(19) United States
(12) Patent Application Publication
(10) Pub. No.: US 2015/0064095 A1
(43) Pub. Date: Mar. 5, 2015

(54) Method of Producing a Molecular Structure

(71) Applicant: Lancaster University Business Enterprise Limited, Lancaster, Lancashire (GB)

(72) Inventors: Colin Lambert, Lancaster (GB); Laith Algharagholy, Lancaster (GB); Steven Bailey, Lancaster (GB); Thomas Pope, Lancaster (GB)

(21) Appl. No.: 14/388,222

(22) PCT Filed: Apr. 5, 2013
(86) PCT No.: PCT/GB2013/050895

§ 371 Date: Sep. 25, 2014

(30) Foreign Application Priority Data
Apr. 7, 2012 (GB) 1206305.3

(51) Int. Cl. C01B 31/04; C01B 31/02

(52) U.S. Cl. CPC C01B 31/0484; C01B 31/02; C01B 31/028; C01B 31/0213
USPC 423/445 R; 264/485

(57) ABSTRACT

A method of producing a molecular structure comprises determining a desired shape of the molecular structure; providing a multi-layer structure, the multilayer structure having at least first and second adjacent generally planar molecular layers, the first and second generally planar molecular layers each consisting of an array of covalently bonded atoms; arranging the multi-layer structure in a desired orientation relative to a cutter; using the cutter to break bonds within the first generally planar molecular layer to produce a first edge of a desired configuration corresponding to the desired shape of the molecular structure; and using the cutter to break bonds within the second generally planar molecular layer to produce a second edge of a desired configuration corresponding to the desired shape of the molecular structure; and allowing the first edge of the first generally planar molecular layer and the second edge of the second generally planar molecular layer to relax so that the first edge of the first generally planar molecular layer and the second edge of the second generally planar molecular layer covalently bond to one another.

This invention relates to a method of producing a molecular structure, and more particularly to a method of producing a molecular structure from a multilayer structure.

The invention also relates to a molecular structure produced by the aforementioned method.

Carbon-containing molecular structures have many applications in industrial and medical fields.

Four types of carbon-containing molecular structure are discussed below.

Graphene is an allotrope of carbon. Its structure is that of single atom thickness planar sheets of sp²-bonded carbon atoms packed in a two-dimensional honeycomb crystal lattice. Each carbon atom within the lattice is found at the intersection of three adjacent six-membered rings. There are various uses for graphene including use in filtration/distillation, use in capacitors, use within biodevices and use as an antibacterial agent. There are also many other potential uses for graphene.

A graphene nanoribbon (GNR) is generally a single layer of graphene which is cut in a particular pattern and/or shape to give the GNR desired properties, such as certain electrical properties. GNRs may provide an alternative to copper for use an integrated circuit interconnects. Furthermore, GNRs have been used to produce field effect transistors (FETs). Consequently, GNRs may replace silicon as the most popular semiconductor in electronics. Moreover, graphene transistors may form part of non-volatile memory.

A fullerene is an allotrope of carbon in the form of a tube, ellipsoid or a sphere. Spherical fullerenes have a structure which includes pentagonal (in addition to hexagonal) rings of carbon atoms which permit the carbon atoms to form a spherical arrangement. Spherical fullerenes have been used to encage and transport atoms and molecules within the human body whilst protecting the encaged atom or molecule from the environment external to the spherical fullerene. Spherical fullerenes may also be used for storing hydrogen and hence may replace metal hydrides within future batteries or full cells.

Another type of fullerene is a carbon nanotube (CNT). CNTs are generally cylindrical molecular structures of carbon. The structure of a single-wall CNT may be described as a one-atom thick layer of graphene rolled into a seamless cylinder. The structure of CNTs may comprise a single cylinder (single-wall) or a concentric arrangement of two or more cylinders. The ends of the cylindrical structure of CNTs may be capped with a hemispherical fullerene which then forms part of the nanotube structure. CNTs have been used to make materials which have a very high tensile strength and toughness. Nanotubes have also been used to create CNT FETs. CNTs have also been used to produce electrical interconnects, paper batteries and ultra capacitors.

Current methods for producing carbon-containing molecular structures such as fullerenes and CNTs can only produce a limited range of shapes of molecular structure. Examples of known production methods for producing carbon-containing molecular structures include chemical vapour deposition (CVD), laser ablation and arc discharge. The further use of carbon-containing molecular structures within industry and medicine is limited by the limited number of shapes of carbon-containing molecular structure which can be fabricated used known techniques. The present invention seeks to obviate or mitigate this problem. It is a further object of the present invention to provide alternative shapes of carbon-containing molecular structures and/or an alternative method for producing carbon-containing molecular structures.

According to a first aspect of the present invention there is provided a method of producing a molecular structure, the method comprising determining a desired shape of the molecular structure; providing a multi-layer structure, the multilayer structure having at least first and second adjacent generally planar molecular layers, the first and second generally planar molecular layers each consisting of an array of covalently bonded atoms; arranging the multi-layer structure in a desired orientation relative to a cutter; using the cutter to break bonds within the first generally planar molecular layer to produce a first edge of a desired configuration corresponding to the desired shape of the molecular structure; and using the cutter to break bonds within the second generally planar molecular layer to produce a second edge of a desired configuration corresponding to the desired shape of the molecular structure; and allowing the first edge of the first generally planar molecular layer and the second edge of the second generally planar molecular layer to relax so that the first edge of the first generally planar molecular layer and the second edge of the second generally planar molecular layer covalently bond to one another.

After the first edge of the first generally planar molecular layer and the second edge of the second generally planar molecular layer have covalently bonded to one another, the covalently bonded first and second generally planar molecular layer may be allowed to deform to produce the desired molecular structure.

The first edge and the second edge may form a first pair of corresponding edges. The method may further include using the cutter to form at least one further pair of corresponding edges. In forming each of the at least one further pair of corresponding edges, the cutter may break bonds within the first generally planar molecular layer to produce a first paired edge of a desired configuration corresponding to the desired shape of the molecular structure; and using the cutter to break bonds within the second generally planar molecular layer to produce a second paired edge of a desired configuration corresponding to the desired shape of the molecular structure.

The molecular structure obtained may depend on the shape of a pair of corresponding edges and/or on the interaction between pairs of corresponding edges.

The multi-layer structure may be a bi-layer structure.

The first and second generally planar molecular layers may have a known relative orientation.

The first and second adjacent generally planar molecular layers may be AB-stacked.

The array of covalently bonded atoms of one or both of the first and second adjacent generally planar molecular layers may be a repeating structure, the repeating structure repeating in two substantially perpendicular directions.

The first and/or second generally planar molecular layer may be one atom thick.

At least one of the first and second generally planar molecular layers may be a graphene layer.

The first and second generally planar molecular layers may have substantially the same composition and/or structure.

The first and second generally planar molecular layers may be graphene layers.

The first and second generally planar molecular layers may have different compositions and/or structures.

A scanning tunnelling microscope may be used to arrange the multi-layer structure in a desired orientation relative to the cutter.

The cutter may be a scanning tunnelling microscope lithography device.

The method may further include cooling the multilayer structure to a temperature at which the relaxation of the first edge of the first generally planar molecular layer and the second edge of the second generally planar molecular layer is relatively inhibited (and/or covalent bonding between the first edge and second edge is relatively inhibited); and subsequently heating the multilayer structure to a temperature at which the relaxation of the first edge of the first generally planar molecular layer and the second edge of the second generally planar molecular layer is relatively permitted (and/or covalent bonding between the first edge and second edge is relatively permitted).

The method may further include chemical or heat treatment or irradiation of the first edge and/or second edge. This may occur prior to the relaxation of the first and second edges.

The cutter may simultaneously break bonds within the first and second generally planar molecular layers to produce the first edge and the second edge respectively.

The first edge and second edge may be separated by a distance which is less than a covalent bond distance between a first atom of the first edge and a second atom of the second edge.

The first edge of the first generally planar molecular layer and the second edge of the second generally planar molecular layer may covalently bond to one another via sp² covalent bonding.

The first edge of the first generally planar molecular layer and the second edge of the second generally planar molecular layer may covalently bond to form a first bonded pair of corresponding edges, and wherein the first bonded pair of corresponding edges may form a closed loop.

The first edge of the first generally planar molecular layer and the second edge of the second generally planar molecular layer may covalently bond to form a first bonded pair of corresponding edges, and the molecular structure may comprise at least one further bonded pair of corresponding edges, the or each of the at least one further bonded pair of edges being formed by: allowing first and second edges of a pair of corresponding edges to relax so that the first and second edges of the pair of corresponding edges covalently bond to one another, wherein to produce each pair of corresponding edges: the cutter break bonds within the first generally planar molecular layer to produce a first edge of the pair of corresponding edges of a desired configuration corresponding to the desired shape of the molecular structure; and the cutter breaks bonds within the second generally planar molecular layer to produce a second edge of the pair of corresponding edges of a desired configuration corresponding to the desired shape of the molecular structure; and wherein first bonded pair of corresponding edges interacts with the at least one further bonded pair of corresponding edges to form the desired molecular structure.

The desired shape of the molecular structure may include a hole through a portion of the molecular structure; and the first edge of the first generally planar molecular layer and the second edge of the second generally planar molecular layer may relax so that the first edge of the first generally planar molecular layer and the second edge of the second generally planar molecular layer covalently bond to one another to form an internal surface of the molecular structure which defines the hole through the portion of the molecular structure. In this context “internal surface” may be taken to mean a surface which is internal to the hole through the portion of the molecular structure or a surface which defines the hole through the portion of the molecular structure. The molecular structure may be generally toroidal in shape, may be a toroid connected to at least one nanoribbon, or may be a toroid connected to at least one nanotube.

The first edge may be a closed bonded edge which defines a hole through the first generally planar molecular layer; and the second edge may be a closed bonded edge which defines a hole through the second generally planar molecular layer. The closed bonded edges may be closed loops.

According to a second aspect of the present invention there is provided a molecular structure produced using the method of any of the preceding claims.

Specific embodiments of the present invention will now be described, by way of example only, with reference to the accompanying drawings in which:

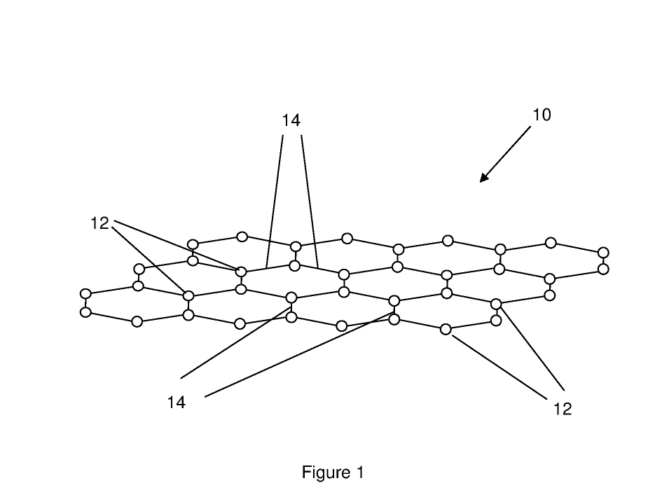

FIG. 1 shows a schematic perspective view of a portion of mono-layer graphene;

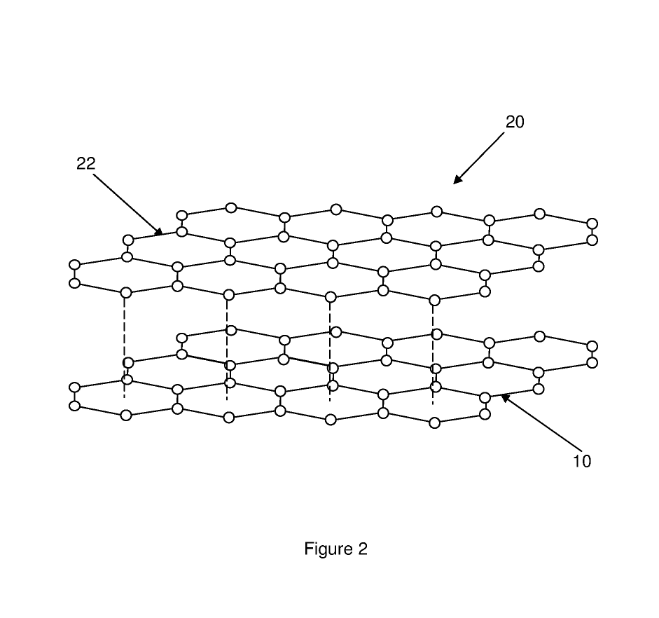

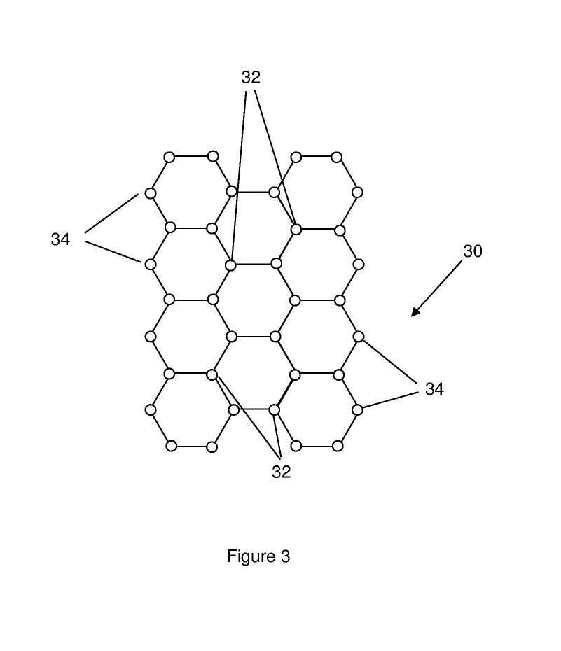

FIG. 2 shows a schematic perspective view of a portion of bi-layer graphene;

FIG. 3 shows a schematic plan view of a portion of a mono-layer graphene nanoribbon (GNR);

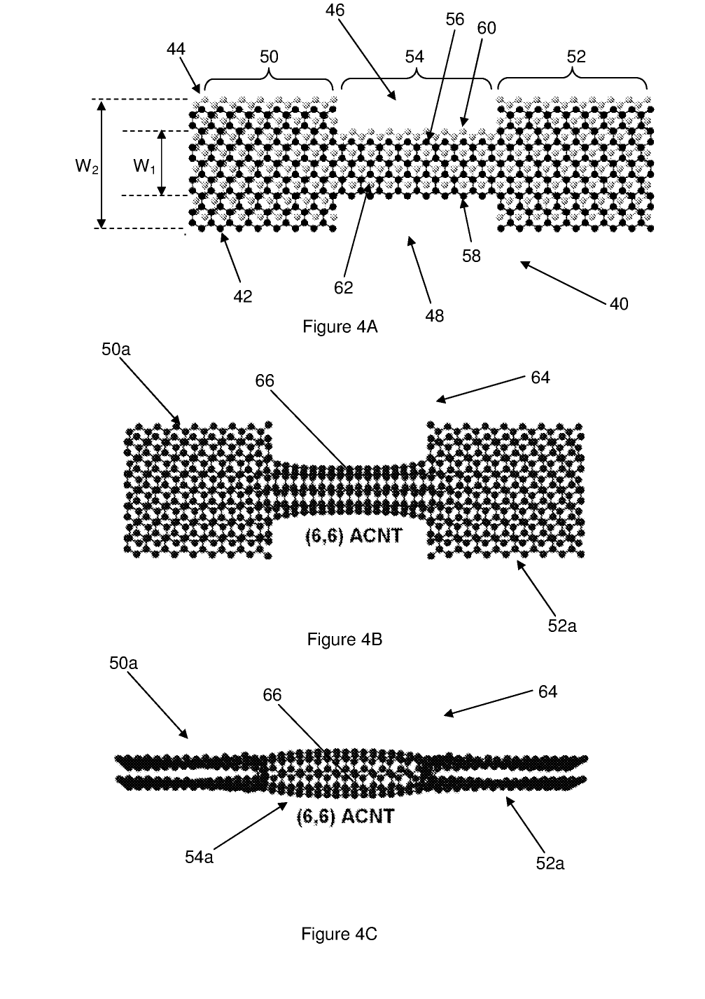

FIG. 4A shows a schematic plan view of a multi-layer structure which forms part of a first embodiment of the present invention;

FIG. 4B and FIG. 4C show a schematic plan view and a schematic side elevation of a molecular structure produced by a first embodiment of the method of the present invention using the multi-layer structure shown in FIG. 4A;

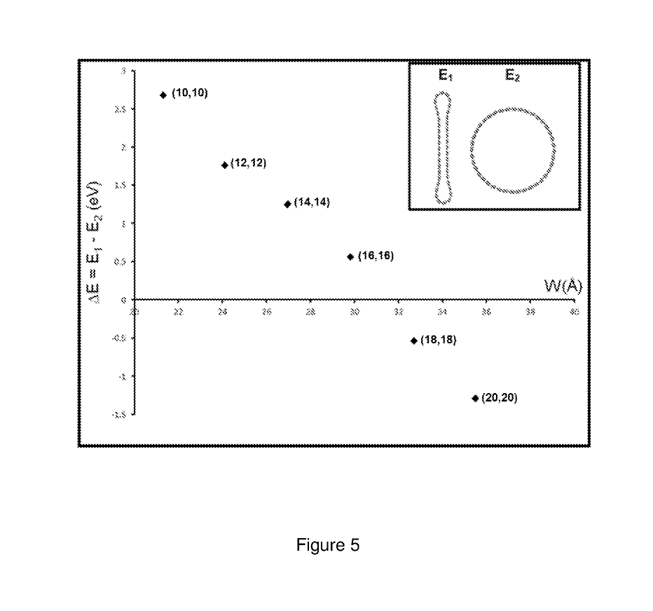

FIG. 5 is a plot of the difference in energy between two states of molecular structure as a function of the width of a GNR multilayer structure which forms the molecular structure;

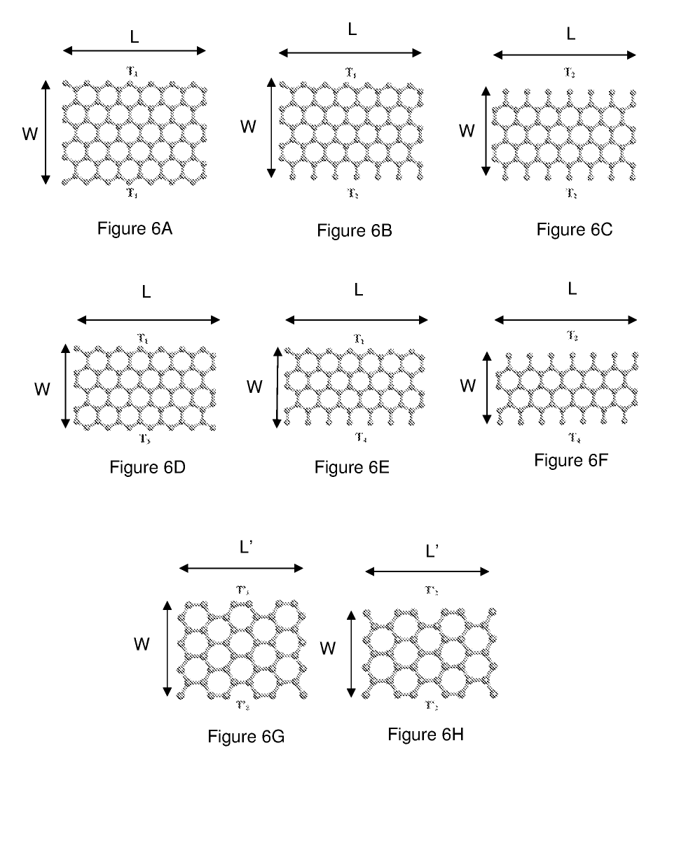

FIGS. 6A to 6H show schematic plan views of eight GNRs each having edges with different types of edge configuration;

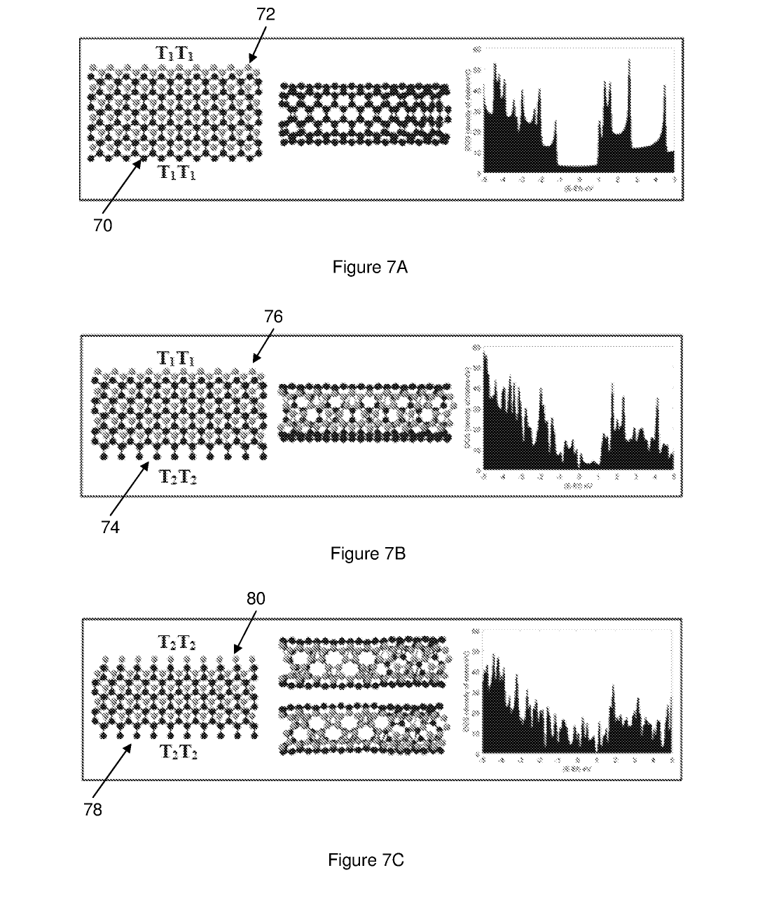

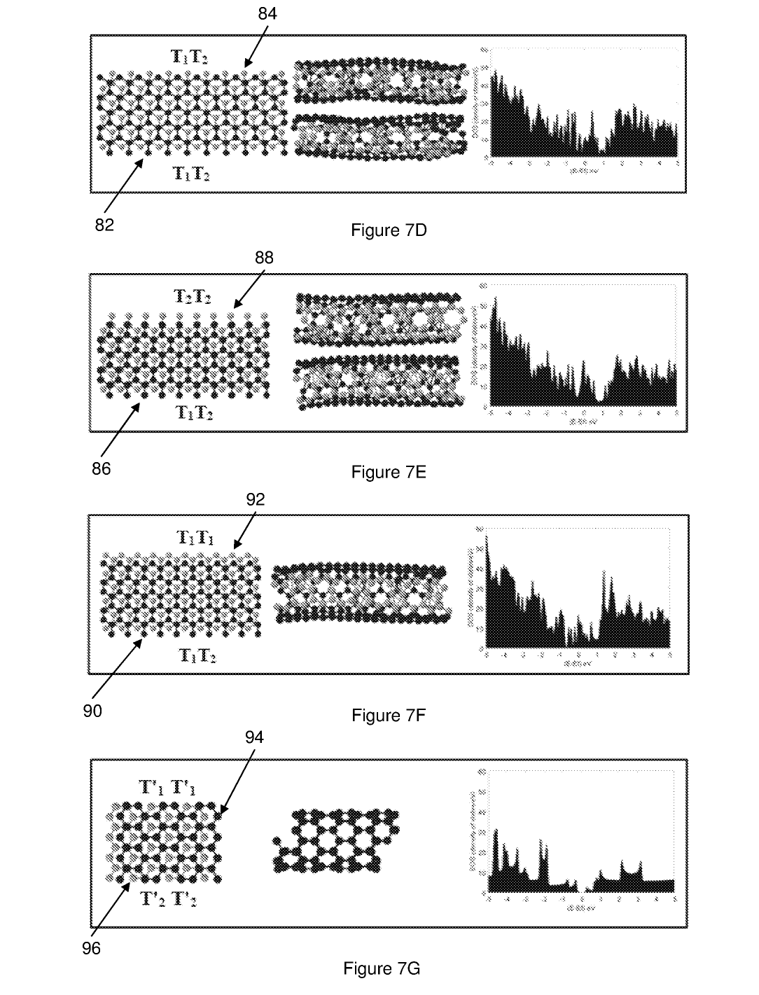

FIGS. 7A to 7G show corresponding schematic plan views of multilayer structures, schematic side views of formed molecular structures, and plots of electronic Density of States (hereafter referred to as Density of States) against energy level for seven embodiments of the present invention;

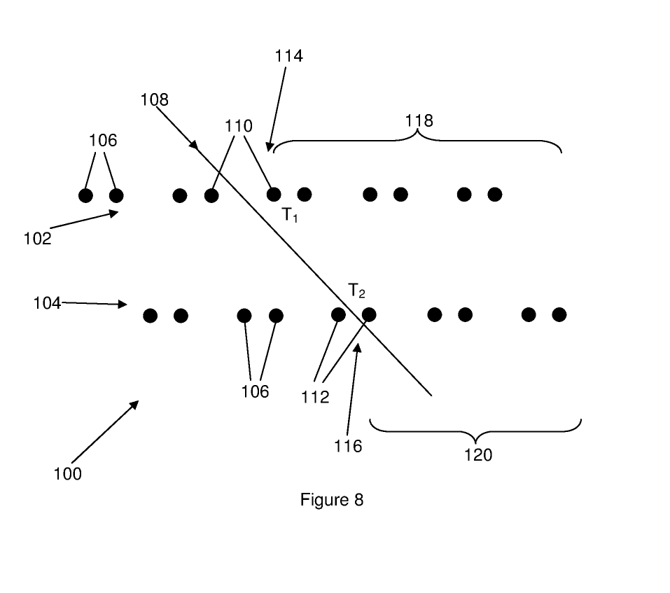

FIG. 8 shows a schematic side view of a cutter being used according to an embodiment of the invention to simultaneously create a first edge in a first molecular layer and a second edge in a second molecular layer;

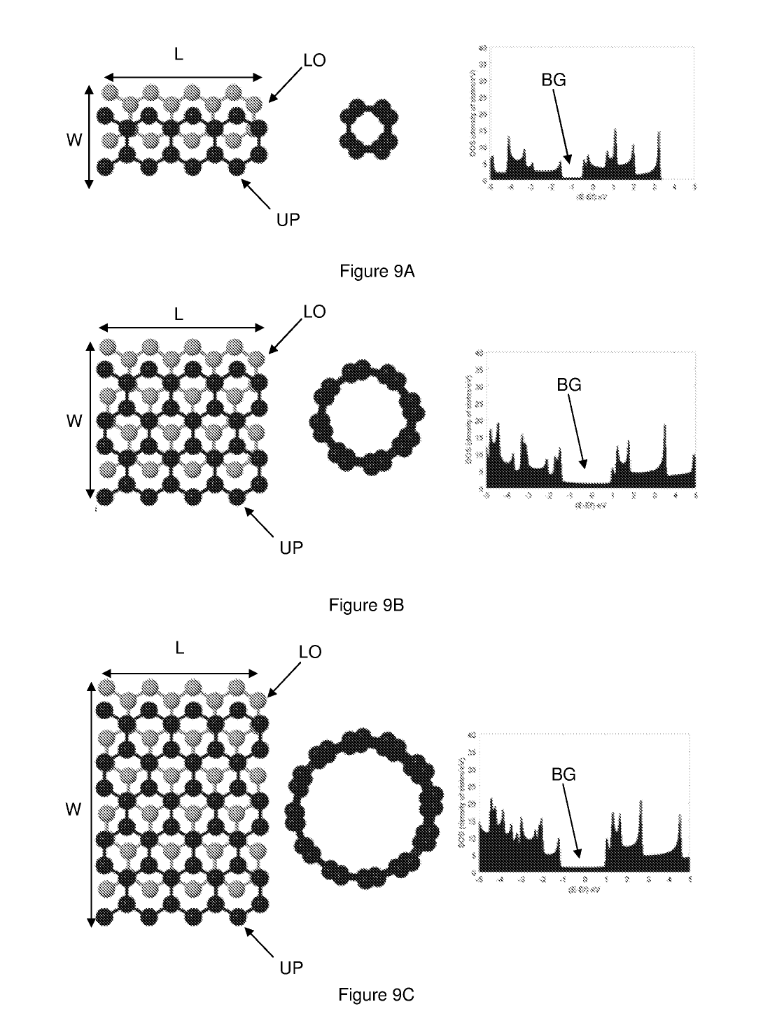

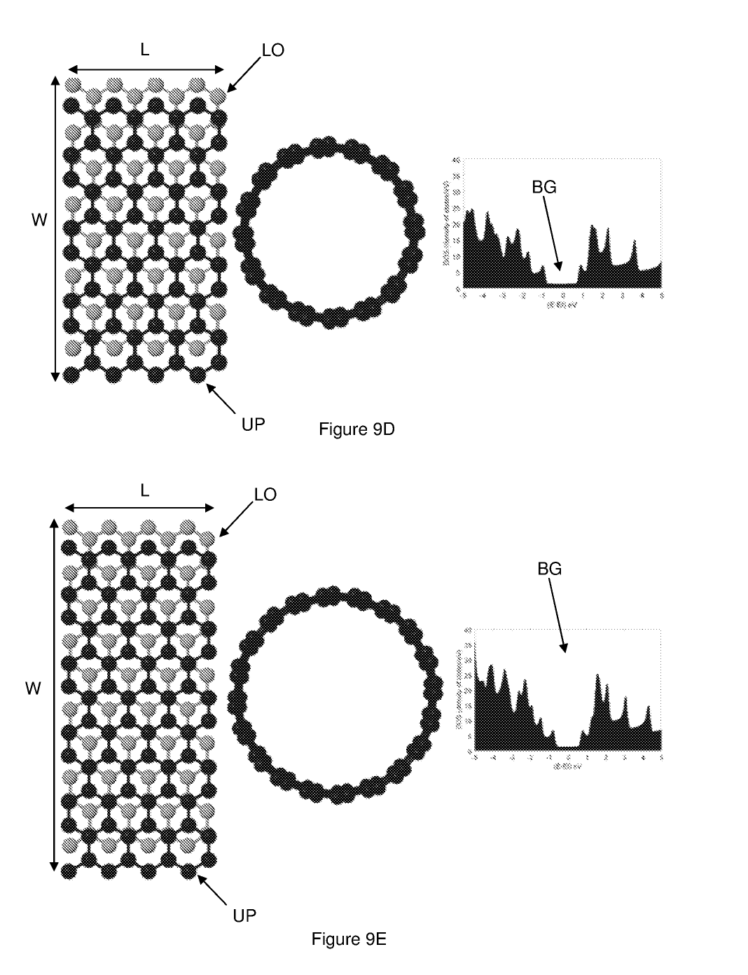

FIGS. 9A to 9E show corresponding schematic plan views of multilayer structures, schematic cross-sectional views of formed molecular structures, and plots of Density of States against energy level for five further embodiments of the present invention;

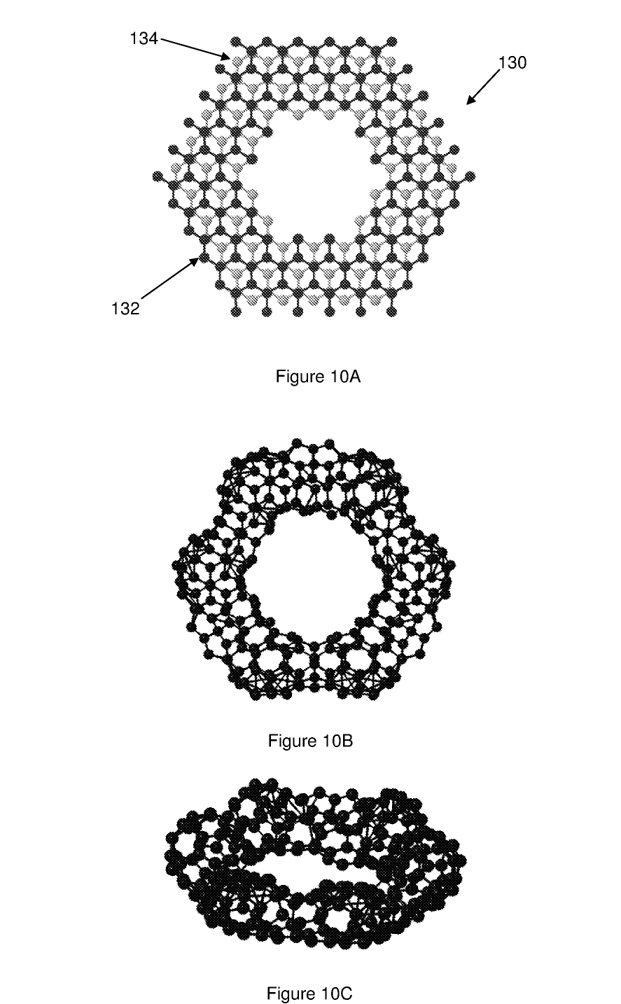

FIG. 10A shows a schematic plan view of a multi-layer structure which forms part of an additional embodiment of the present invention;

FIG. 10B and FIG. 10C show a schematic plan view and a schematic perspective view of a molecular structure produced by said additional embodiment of the method of the present invention using the multi-layer structure shown in FIG. 10A;

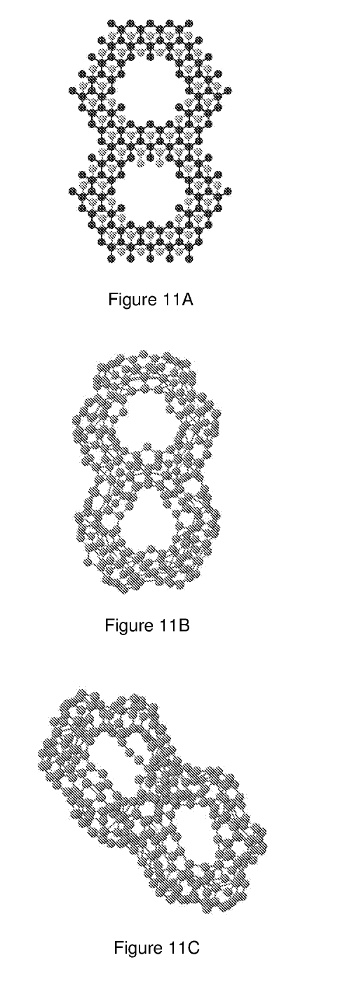

FIG. 11A shows a schematic plan view of a multi-layer structure which forms part of an additional embodiment of the present invention;

FIG. 11B and FIG. 11C show a schematic plan view and a schematic perspective view of a molecular structure produced by said additional embodiment of the method of the present invention using the multi-layer structure shown in FIG. 11A;

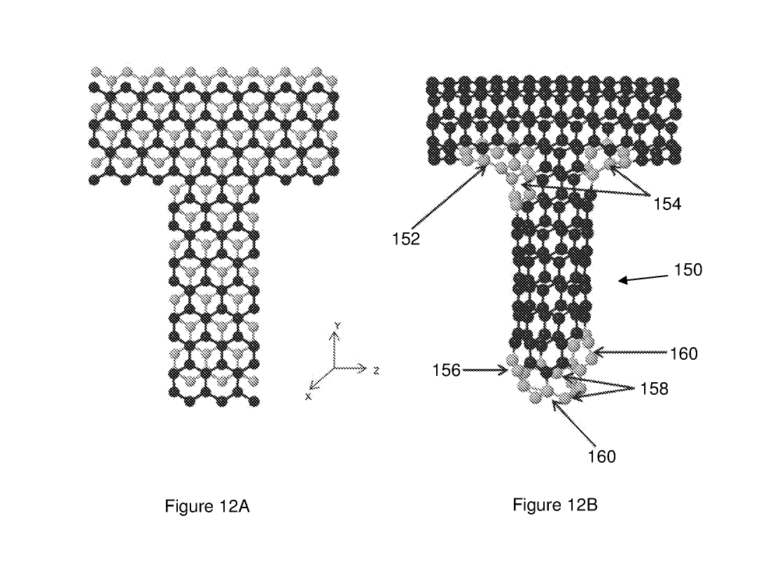

FIG. 12A shows a schematic plan view of a multi-layer structure which forms part of another embodiment of the present invention;

FIG. 12B shows a schematic plan view of a molecular structure produced by said another embodiment of the present invention using the multi-layer structure shown in FIG. 12A;

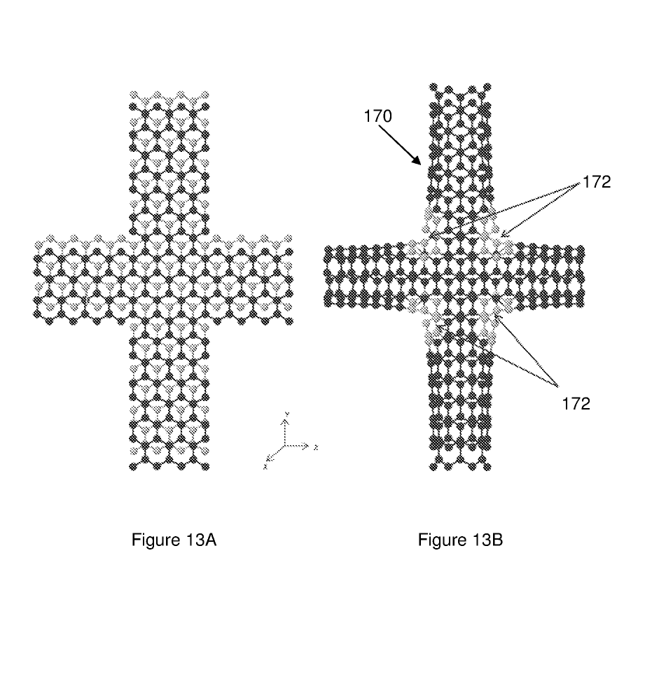

FIG. 13A shows a schematic plan view of a multi-layer structure which forms part of another embodiment of the present invention;

FIG. 13B shows a schematic plan view of a molecular structure produced from the multi-layer structure shown in FIG. 13A;

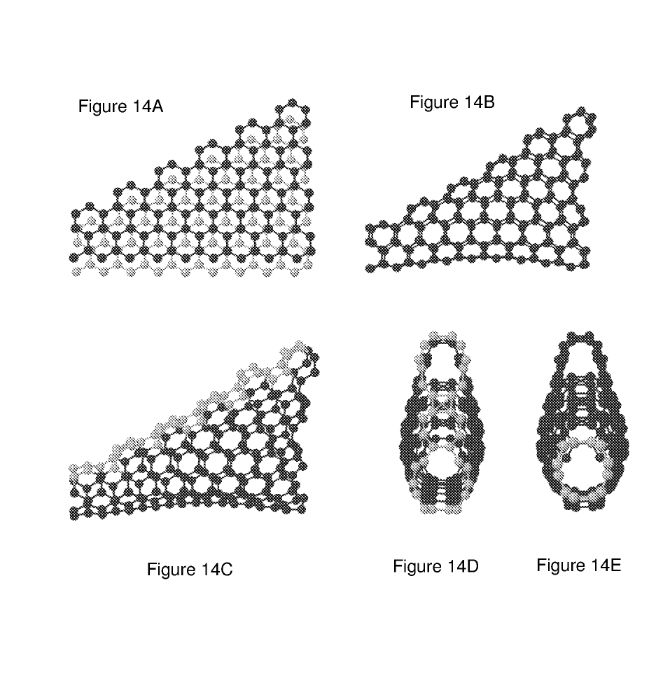

FIG. 14A shows a schematic plan view of a multi-layer structure which forms part of another embodiment of the present invention;

FIGS. 14B to 14E show schematic views of a molecular structure produced from the multi-layer structure shown in FIG. 14A;

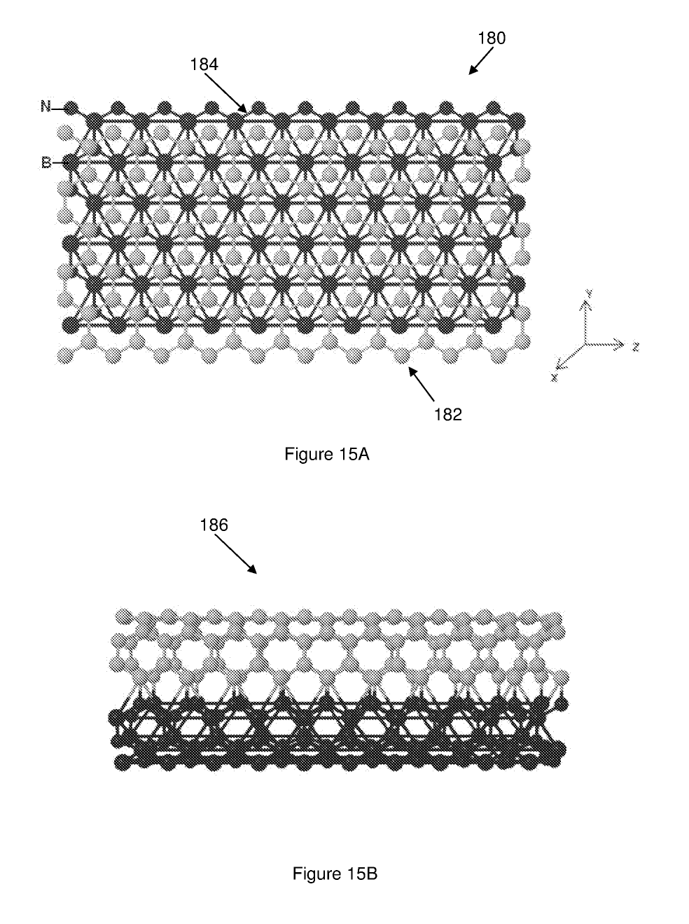

FIG. 15A shows a schematic plan view of a hetero-bi-layer multi-layer structure which forms part of another embodiment of the present invention;

FIG. 15B shows a schematic side view of a molecular structure produced from the multi-layer structure shown in FIG. 15A;

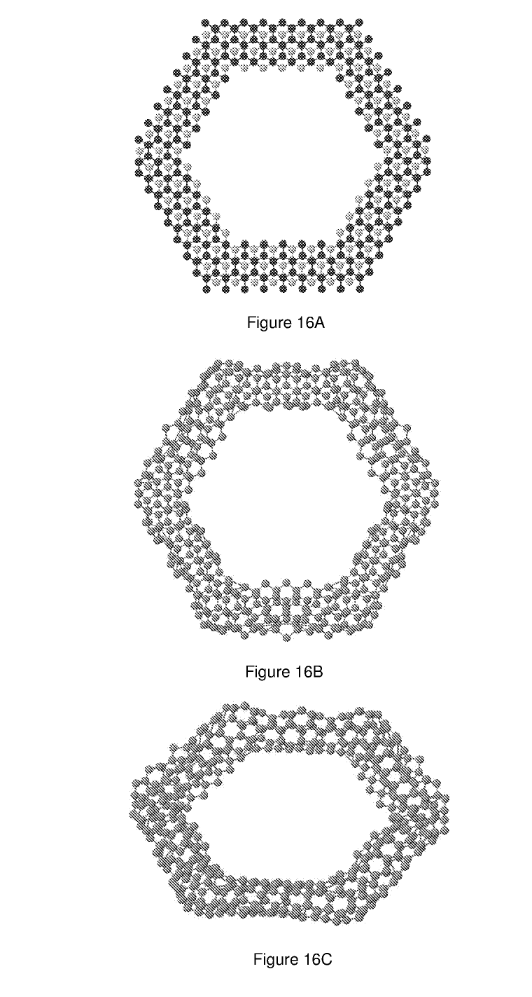

FIG. 16A shows a schematic plan view of a multi-layer structure which forms part of a further embodiment of the present invention;

FIG. 16B and FIG. 16C show a schematic plan view and a schematic perspective view of a molecular structure produced by said further embodiment of the method of the present invention using the multi-layer structure shown in FIG. 16A;

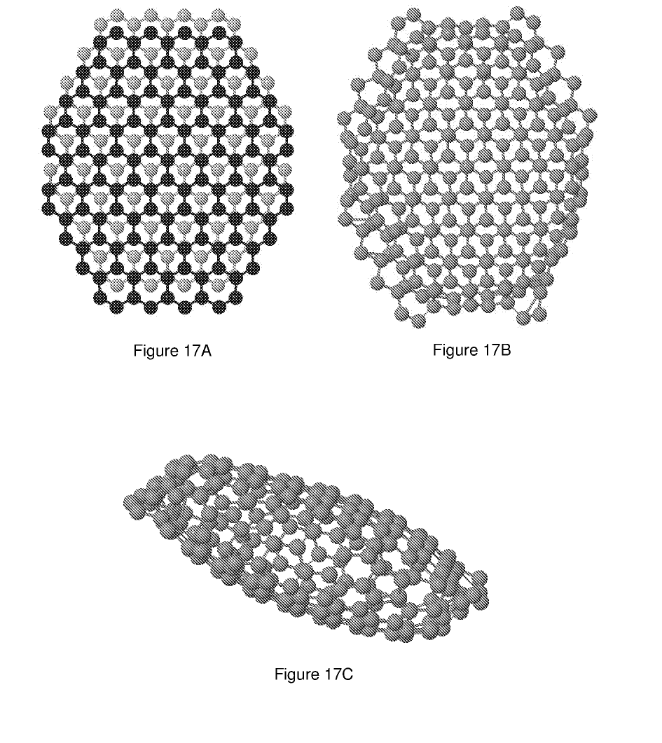

FIG. 17A shows a schematic plan view of a multi-layer structure which forms part of an additional embodiment of the present invention;

FIG. 17B and FIG. 17C show a schematic plan view and a schematic perspective view of a molecular structure produced by said additional embodiment of the method of the present invention using the multi-layer structure shown in FIG. 17A;

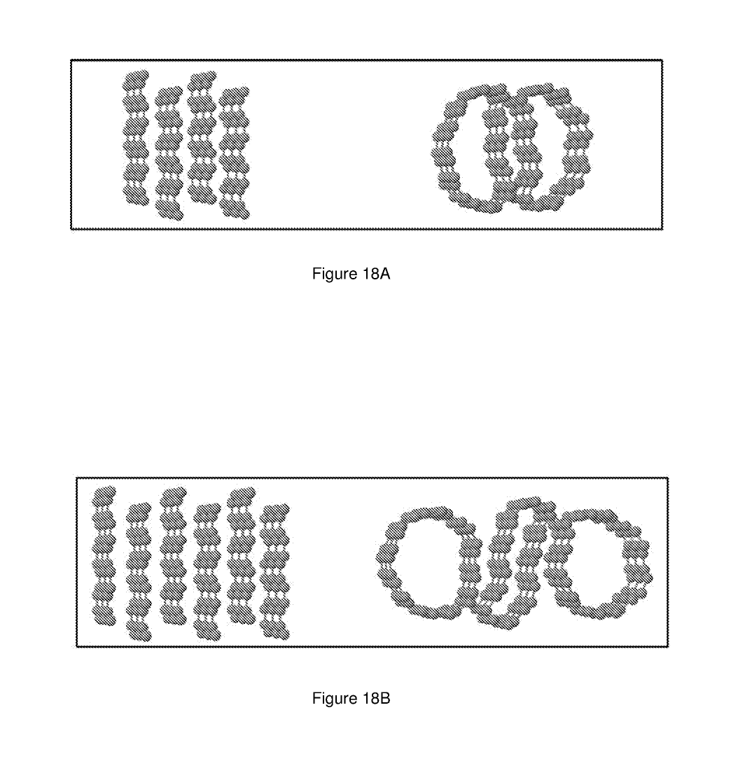

FIGS. 18A and 18B show schematic views of portions of two separate multilayer structures and corresponding portions or molecular structures which are produced from the respective multilayer structure by the present invention;

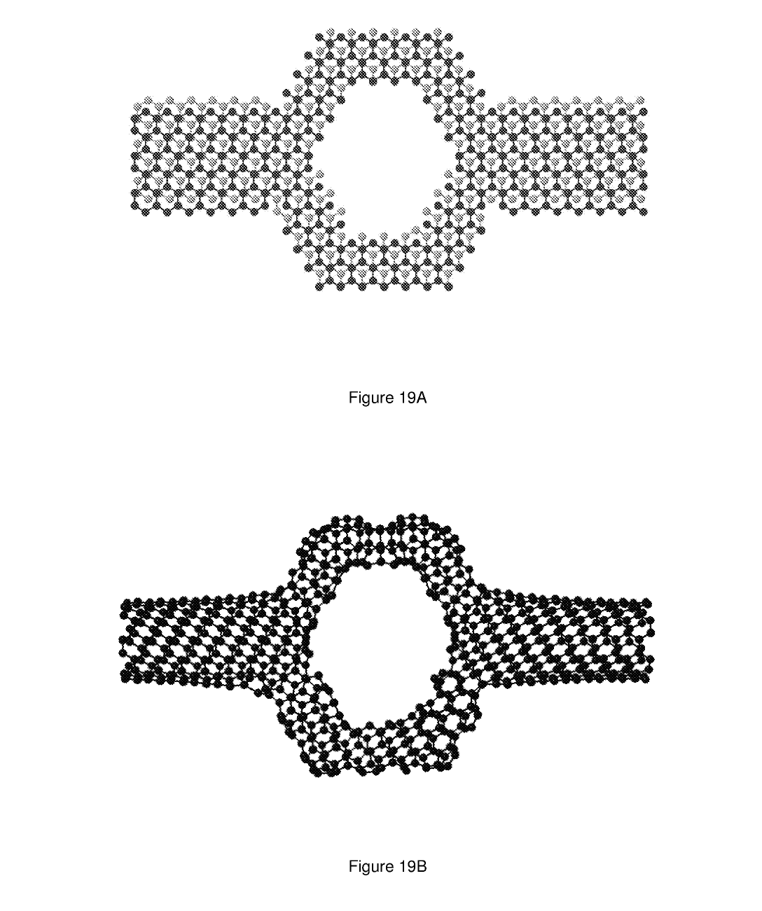

FIG. 19A shows a schematic plan view of a multi-layer structure which forms part of a further embodiment of the present invention;

FIG. 19B shows a schematic plan view of a molecular structure produced by said further embodiment of the method of the present invention using the multi-layer structure shown in FIG. 19A;

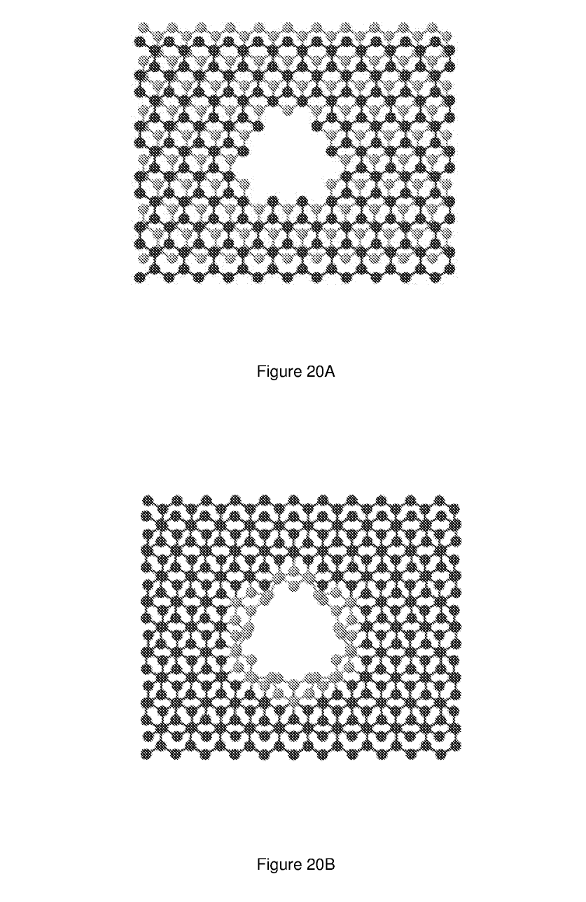

FIG. 20A shows a schematic plan view of a multi-layer structure which forms part of an additional embodiment of the present invention;

FIG. 20B shows a schematic plan view of a molecular structure produced by said additional embodiment of the method of the present invention using the multi-layer structure shown in FIG. 20A;

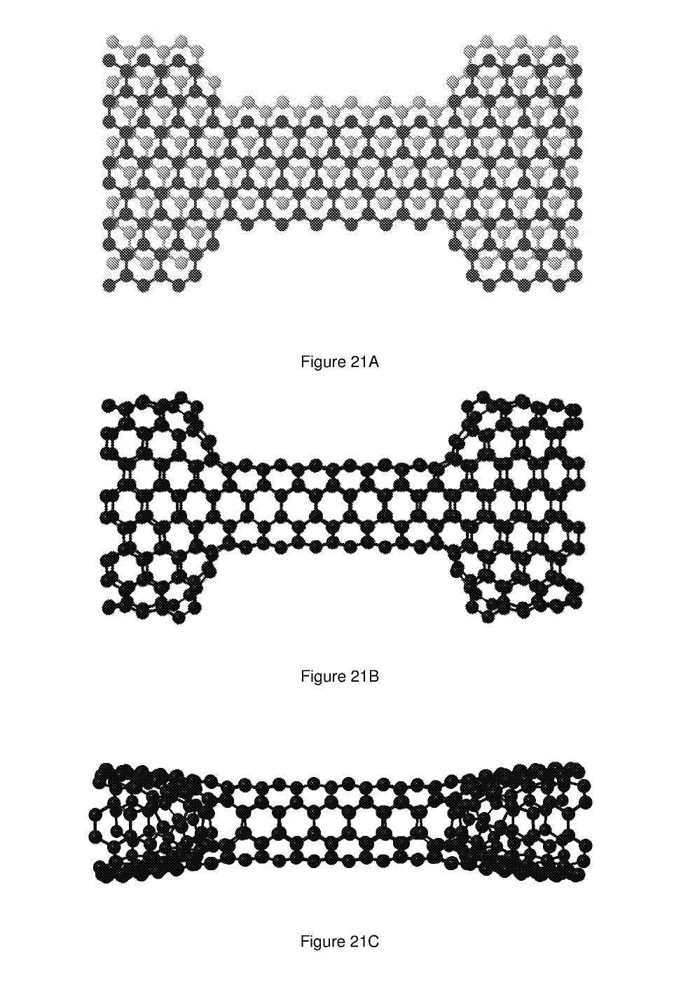

FIG. 21A shows a schematic plan view of a multi-layer structure which forms part of a further embodiment of the present invention; and

FIGS. 21B and 21C show a schematic plan view and a schematic side view of a molecular structure produced by said further embodiment of the method of the present invention using the multi-layer structure shown in FIG. 21A.

FIG. 1 is a schematic diagram showing a perspective view of the structure of a portion of a single layer of graphene. A single layer of graphene may also be referred to as a graphene monolayer or a monolayer graphene sheet. The monolayer graphene sheet 10 is a planar molecular layer consisting of an array of covalently bonded carbon atoms 12. Each carbon atom 12 (other than those at the edges of the sheet 10) is connected by three respective covalent bonds 14 to three adjacent carbon atoms 12. The covalent bonds 14 are sp² covalent bonds. The structure of the sheet 10 is such that the carbon atoms 12 are packed in a two-dimensional honeycomb crystal lattice (i.e., consisting of tessellated hexagons or hexagonal rings).

FIG. 2 shows a multilayer structure. In this case the multilayer structure 20 is a bilayer graphene structure. That is to say that the multilayer structure 20 has two graphene monolayers stacked on top of each other. The graphene monolayer shown in FIG. 1 and indicated by 10 is a first graphene monolayer (also referred to as a first layer) of the bilayer graphene structure 20. A second graphene monolayer 22 (also referred to as a second layer) is stacked on the first graphene monolayer 10.

The first and second graphene monolayers can be said to be stacked in an AB configuration (or AB-stacked). A graphene bilayer which is AB stacked may be referred to as an AB stacked graphene bilayer or AB graphene bilayer. It can be seen that in an AB stacked graphene bilayer the planar layers are parallel and orientated relative to one another such that within either of the layers, three of the carbon atoms forming part of a hexagonal group of six carbon atoms are located directly above (or below) carbon atoms of the other layer. In this context, directly above or below means located in a direction from the layer which is perpendicular to the plane of the layer. Furthermore, the other three carbon atoms of the six carbon atoms which form the hexagonal group are located directly above or below the central ‘empty’ spaces defined by a hexagonal group of six carbon atoms in the other layer.

The first and second molecular layers 10, 20 are weakly bonded adjacent to one another by van der Waals forces.

Another type of known molecular structure containing carbon is a fullerene. A fullerene is a carbon allotrope in the form of a sphere, ellipsoid or tube. A spherical (or ellipsoid) fullerene has a similar structure to that of graphene shown in FIG. 1. However, the structure of a spherical (or ellipsoid) fullerene is such that the carbon atoms within it form pentagonal rings as well as hexagonal rings. The combination of pentagonal and hexagonal rings means that, unlike graphene, the surface of a spherical (or ellipsoid) fullerene is curved.

An example of a tubular fullerene is a carbon nanotube (CNT). CNTs generally comprise or consist of a monolayer graphene sheet that is rolled into a generally cylindrical arrangement. Some CNTs may comprise a concentric arrangement of two or more cylinders formed from a rolled monolayer graphene sheet. The ends of the cylindrical portion of the CNT structure (which, as discussed, may comprise a rolled sheet of graphene) may be capped with spherical or ellipsoid fullerene hemispheres which form part of the nanotube structure.

A variety of techniques have been used for producing fullerenes. These methods include arc discharge, laser ablation and chemical vapour deposition (CVD).

A further type of known carbon-containing molecular structure is a graphene nanoribbon (GNR). It is known to form graphene nanoribbons (GNRs) from monolayer graphene having a structure as shown in FIG. 1. A schematic plan view of the structure of a GNR formed from a graphene monolayer is shown in FIG. 3. The carbon atoms within the GNR 30 shown in FIG. 3 are bonded to their neighbouring carbon atoms in two different ways. The carbon atoms 32 which are relatively towards the centre of the GNR are sp²-bonded to three adjacent carbon atoms. However, the some carbon atoms 34 which are located at the edge of the GNR are only bonded to two adjacent carbon atoms and are hence not sp²-bonded.

It is thought that the lack of sp²-bonding in the carbon atoms 34 at the edge of the GNR leads to potentially undesirable properties of the GNR. For example, the lack of sp²-bonding in the carbon atoms 34 at the edge of the GNR may result in greater electrical resistance compared to a similar structure in which all of the carbon atoms are sp²-bonded. Also, due to the fact that the edges of a GNR are not covalently sp²-bonded, for a given energy gap, the electron mobility of GNRs is typically significantly lower than that of CNTs.

Known methods for creating GNRs include lithographic, chemical and sonochemical techniques, as well as production from CNTs and assembling GNRs from chemical precursors. One known method of producing GNRs is to cut a graphene monolayer into a desired shape using scanning tunnelling microscopy (STM) lithography.

The shapes of carbon-containing molecular structures which can be manufactured using the known techniques mentioned above are limited. Consequently, the present invention seeks to provide an alternative method of producing molecular structures which have shapes that cannot be produced using known techniques. Furthermore, the present invention seeks to provide a method of producing molecular structures which have desirable properties when compared to the properties of molecular structures which can be produced using known techniques.

The applicant has found that, surprisingly, by cutting a multilayer structure, it is possible to create carbon-containing molecular structures having a shape which cannot be produced using known molecular structure production methods. These new shapes of carbon-containing molecular structure can be produced using the present invention due to the fact that once the multilayer structure has been cut, covalent bonding occurs between adjacent layers within the multilayer structure. The invention is described in more detail below.

FIG. 4A shows a multilayer structure 40, the multilayer structure having first and second adjacent generally planar molecular layers. The first and second molecular layers are indicated by 42 and 44. The first and second generally planar molecular layers 42, 44 have a known relative orientation in that they are AB-stacked (the first layer 42 lying on top of the second layer 44 in the Figure). Each of the first and second layers 42, 44 consists of an array of covalently-bonded atoms. In this case, each of the first and second layers 42, 44 consists of an array of sp²-bonded carbon atoms. The structure of the multilayer structure is as shown in FIG. 2. In this case the multilayer structure is a graphene bilayer.

FIG. 4A shows the multilayer structure after the multilayer structure 40 has been arranged in a desired orientation relative to a cutter and the cutter has been used to break bonds within the first and second generally planar molecular layers 42, 44. In this case, the cutter is a STM lithography device which has been used to create first and second recesses 46, 48 in the multilayered structure 40. The recesses 46, 48 define first and second end portions 50, 52 of the multilayer structure, which are either side of a central portion 54. That is to say, the central portion 54 of the multilayer structure 40 is located between the end portions 50, 52 of the multilayer structure 40.

It can be seen that the width W1 of the central portion 54 that is defined by the recesses 46, 48 is less than the width W2 of the end portions 50, 52.

As previously discussed, the cutter produces the first and second recesses 46, 48 which break bonds within the first generally planar molecular layer 44 to produce a first edge 56 and a third edge 58 of the first generally planar molecular layer 42. The cutter is also used to break bonds within the second generally planar molecular layer 44 to produce a second edge 60 and a fourth edge 62.

The first edge 56 of the first layer 42 and the second edge 60 of the second layer 44 are allowed to relax (which may also be referred to a being allowed to reconstruct and deform) such that the carbon atoms along the first edge 56 covalently bond to corresponding carbon atoms of the second edge 60. The covalent bonding between the atoms of the first edge 56 and the atoms of the second edge 60 is, in this case, sp²-bonding. The first edge 56 of the first layer 42 and the second edge 60 of the second layer 44 may be said to be a first pair of corresponding edges. Once the first edge 56 of the first layer 42 and the second edge 60 of the second layer 44 have bonded to one another, the bonded first and second edges 56, 60 may be referred to as a first pair of bonded corresponding edges.

The third edge 58 of the first layer 42 and the fourth edge 62 of the second layer 44 are also allowed to relax so that carbon atoms of the third edge 58 of the first layer 42 covalently bond to corresponding carbon atoms of the fourth edge 62 of the second molecular layer 44. Again, the bonding between the atoms of the third and fourth edges 58, 62 is sp²-bonding. The third edge 58 of the first layer 42 and the fourth edge 62 of the second layer 44 may be said to be a second, further pair of corresponding edges. Once the third edge 58 of the first layer 42 and the fourth edge 62 of the second layer 44 have bonded to one another, the bonded third and fourth edges 58, 62 may be referred to as a second, further pair of bonded corresponding edges.

As part of the relaxation, all atoms of the structure 40 are allowed to adjust their positions and the shape as a whole is allowed to deform.

In order to produce molecular structures according to the other embodiments of the present invention, the cutter may be used to form any appropriate number (e.g. 1, 2, 3 or more) of further pairs of corresponding edges. In forming each of the further pairs of corresponding edges, the cutter will break bonds within the first generally planar molecular layer to produce a first edge of the pair of corresponding edges having a desired configuration corresponding to the desired shape of the molecular structure; and the cutter will break bonds within the second generally planar molecular layer to produce a second edge of the pair of corresponding edges having a desired configuration corresponding to the desired shape of the molecular structure. For each further pair of corresponding edges, the atoms of the first and second edges of the pair of corresponding edges will covalently bond to one another to form a further pair of bonded corresponding edges. The molecular structure obtained may depend on the shape of a pair of corresponding edges and/or on the interaction between bonded pairs of corresponding edges.

FIGS. 4B and 4C show a schematic view of a molecular structure 64 which has been formed by the method of the present invention by allowing the multilayer structure 40 shown in FIG. 4A to relax such that the carbon atoms of the first and second edges, and third and fourth edges covalently bond to one another and the structure as a whole deforms. FIG. 4B shows a plan view of the molecular structure and FIG. 4C shows a side elevation of the molecular.

It can be seen that the central portion 54 of the multilayer structure has become a CNT portion 66. In order to form the CNT region 66, not only have the atoms of the first and second edges, and third and fourth edges covalently bonded to one another, but also the first and second layers 42, 44 of the multilayer structure 40 have deformed to decrease the energy associated with the covalently-bonded edges. This deformation of the multilayer structure so as to decrease the energy associated with the covalently-bonded edges is part of the process in which the edges of the molecular layers of the multilayer structure are allowed to relax. In this case, the CNT is an aligned CNT (ACNT) with a chiral vector (6, 6).

It can be seen clearly in FIG. 4C that the molecular structure 64 is such that the central portion 54 of the multilayer structure 40 has deformed to form a CNT 66 via the covalent bonding between the first and second edges, and third and fourth edges respectively; whereas the end portions 50, 52 of the multilayer structure remain as adjacent generally planar molecular layers. The reason for this is explained below.

FIG. 5 shows a plot of energy difference (ΔE) against multilayer structure width (W). The energy difference DE is given by E₁-E₂, where E₂ is the energy of a CNT which has been formed from a bilayer GNR having a width W, and where E₁ is the energy of two substantially adjacent parallel graphene monolayers which are joined at their edges. The plot points correspond to CNTs having chiral vectors (10, 10), (12, 12), (14, 14), (16, 16), (18, 18), and (20, 20). A schematic axial cross-sectional view of the structures which define E₁ and E₂ is provided at the top right hand side of the plot. It can be seen from the graph that if the bilayer GNR has a width (W) which is less than about 31 Å then ΔE is positive. This means that for a bilayer GNR which has a width that is less than about 31 Å, the energy of E₂ (i.e., the energy of a CNT formed from the bilayer GNR) is less than E₁ (i.e., the energy of two parallel adjacent molecular layers which are bonded at the edges and which have been formed from the bilayer GNR). Consequently, it is energetically favourable for a molecular structure formed from a bilayer GNR having a width which is less than about 31 Å to form a CNT.

Likewise, the graph shows that if the width of the bilayer GNR is greater than about 31 Å then ΔE is negative. This means that for a bilayer GNR which has a width which is greater than about 31 Å, E₁ (i.e., the energy of two parallel adjacent molecular layers which are bonded at the edges and which have been formed from the bilayer GNR) is less than E₂ (i.e., the energy of a CNT formed from the bilayer GNR). Consequently, for bilayer GNRs having a width which is greater than about 31 Å, it is energetically favourable for the bilayer GNR to form parallel adjacent molecular layers with bonded edges.

It follows, referring back to the multilayer structure and molecular structure shown in FIGS. 4A to 4C, due to the fact that the end portions 50 and 52 of the multilayer structure 40 have a width W₂ which is greater than about 31 Å, when the molecular structure 64 is formed, these portions 50a, 52a retain a structure which is substantially that of two adjacent parallel graphene layers. In contrast, due to the fact that the central portion 54 of the multilayer structure 40 has a width W₁ which is less than about 31 Å, when the molecular structure 64 is formed; this portion 54a forms a CNT-type structure 66.

It is thought that the deformation of the central portion 54 into a CNT is a consequence of the interaction between two nearby substantially parallel bonded pairs of corresponding edges. The first formed by relaxation of edges 56 and 60 and the second formed from relaxation of edges 58 and 62. It is thought that if the bonded pairs of corresponding edges are too far apart, then instead of the cylindrical structure labelled E₂ in the inset of FIG. 5, the flattened structure labelled E₁ (in the inset of FIG. 5) will be formed as previously discussed.

The molecular structure shown in FIG. 4 has several advantages over known molecular structures. The molecular structure may be used as an electrical component in which the CNT 66 of the central portion 54A of the molecular structure 64 is electrically connected between two electrodes constituted by the end portions 50A, 52A of the molecular structure 64. It may also be said that the portions 50A, 52A of the molecular structure 64 provide low electrical resistance contacts to each end of the CNT 66.

If a similar structure were to be cut from a graphene monolayer, this would form a GNR between two electrodes. As previously discussed, this structure may be disadvantageous compared to the molecular structure 60 due to the fact that the edges of the GNR will not be covalently sp²-bonded and, consequently, the GNR will have a greater resistance than the CNT of the molecular structure 60. A greater resistance may be disadvantageous in some applications due to the fact that the greater resistance (given a constant current) will cause more power to be dissipated by the component as heat. In addition, due to the fact that the edges of a GNR are not covalently sp²-bonded, for a given energy gap, the electron mobility of this structure may be significantly lower than that of the CNT which forms part of the molecular structure 64.

It may also be possible using known production techniques to create a similar molecular structure to that shown in FIGS. 4B and 4C by attaching a prefabricated CNT at each of its ends to respective electrodes. The process of electrically connecting each end of a prefabricated CNT to an electrode can be difficult and time consuming. One reason for this is that it may be difficult to manipulate the CNT and locate it correctly on the electrodes. A further reason for this is that it may be difficult to create an effective electrical connection between the CNT and the electrodes. Consequently, the present invention provides a method of conveniently producing a structure in which a CNT is effectively connected both mechanically and electrically at each of its ends between two electrodes.

It will be appreciated that the chirality of the CNT 66 can be chosen by cutting the bilayer along a chosen crystallographic direction.

It is possible to use the present invention to create molecular structures having a variety of different shapes. In order to predict the shape of a molecular structure which is formed by cutting a particular shape out of a multilayer structure, the relaxation of the multilayer structure whereby atoms of one layer covalently bond with atoms of an adjacent layer can be modelled. For example, the relaxation may be modelled using density functional theory (DFT). For example, the relaxation may be modelled using the SIESTA implementation of DFT. SIESTA (Spanish Initiative for Electronic Simulations with Thousands of Atoms) is a well known method and software implementation for performing electronic structure calculations and ab initio molecular dynamics simulations of molecules and solids.

Using the DFT code of SIESTA, structural optimisation (e.g. to predict the shape of a molecular structure which is formed according to the present invention by cutting a particular shape out of a multilayer structure) may be performed using both the local density approximation (LDA) with norm-conserving pseudopotentials, double zeta polarized (DZP) basis sets of pseudo atomic orbitals and a force tolerance of 0.005 eV/Å. The Ceperley-Alder exchange correlation functional may also be used. Where appropriate, simulations may also be carried out using periodic boundary conditions. Since reconstruction of a multilayer structure (e.g. a bilayer) can lead to relaxed structures with unit cells which are larger than those of the original multilayer structure (e.g. bilayer), the relaxed supercells may involve many unit cells (e.g. bilayer GNR unit cells). When computing the total energies E₁ and E₂ of FIG. 5, the counterpoise method was used to eliminate basis set errors. A selection of results were recalculated using the generalised gradient approximation (GGA) and no significant difference in the relaxed structures were obtained.

Examples of different shapes of molecular structure which can be produced according to the present invention are discussed later within the application.

Not only is the shape of the multilayer structure which is cut important in defining the shape of the molecular structure which will be produced by the method according to the present invention, but the configuration of the edges of each of the layers of the multilayer structure which are cut is also important. When the edges of two adjacent layers are allowed to relax and covalently bond to one another, and then subsequently deform, the shape of the covalently bonded edges depends on the terminations (or edge configurations) of the first and second edges. This is discussed below.

FIGS. 6A to 6H show the structures of portions of eight GNRs. Within FIGS. 6A to 6F the shown portion of the GNRs are each of the same length L. The structures of the GNRs shown in FIGS. 6A to 6H differ from one another in that they have different edge configurations. The structures of the GNRs in FIGS. 6A to 6F are such that the GNRs may be referred to zigzag terminated GNRs (or ZGNRs). The structures of the GNRs in FIGS. 6G and 6H are such that these GNRs may be referred to as armchair terminated GNRs (or AGNRs).

FIG. 6A shows a ZGNR which has upper and lower edges which are of same type of configuration and are marked T₁. Within the description of FIGS. 6A to 6H, upper and lower are used to refer to the relative position of the edges on the page. The GNR shown in FIG. 6A has a width W which is equal to 8a_{c-c}. a_{c-c} is the length of the bond between carbon atoms in the monolayer of graphene.

FIG. 6B shows the structure of a ZGNR which has an upper edge having the same type of configuration as the configuration of the upper and lower edges in FIG. 6A. The GNR in FIG. 6B has a lower edge which has a different type of configuration to the configuration of the upper edge. The configuration of the lower edge is labeled T₂. The width W of the GNR shown in FIG. 6B is 7.5a_{c-c}.

FIG. 6C shows the structure of a ZGNR which has upper and lower edges which have the same type of configuration as the configuration as the lower edge of the GNR shown in FIG. 6B and which are also labeled T₂. The width W of the GNR shown in FIG. 6C is 7a_{c-c}.

FIG. 6D shows the structure of a ZGNR having a lower edge which has a type of configuration that is different to the configuration of any of the edges shown in FIGS. 6A to 6C. This type of configuration is labeled T₃. The width W of the GNR in FIG. 6D is 6.5a_{c-c}.

FIG. 6E shows the structure of a ZGNR having a lower edge with a type of configuration which again is different to the edge configuration in shown in any of FIGS. 6A to 6D. This edge configuration is labeled T₄. The width W of the GNR shown in FIG. 6E is 6a_{c-c}.

FIG. 6F shows a further GNR. This GNR has an upper edge with a configuration that is of the type T₂ and a lower edge which has a configuration of the type T₄. The width W of the GNR shown in FIG. 6F is 5.5a_{c-c}.

FIGS. 6G and 6H show the structure of two AGNRs which both have the same length L′. The types of configuration of the upper edge and the lower edge of FIG. 6G are different. The configuration of the upper edge is labeled T′₁ and the configuration of the lower edge is labeled T′₂. The width W of the GNR shown in FIG. 6G is 7×√3/2 a_{c-c}. FIG. 6H shows a further GNR in which both the upper and lower edges of the GNR have the same type of configuration as that of the lower edge of the GNR shown in FIG. 6G. Consequently, both the edges of the GNR shown in FIG. 6H are of the type T′₂. The width W of the GNR shown in FIG. 6H is 6×√3/2 a_{c-c}.

It will be appreciated that a ZGNR or an AGNR may have any appropriate combination of upper and lower edge configurations. I.e., the combinations of edge configurations shown in FIGS. 6A to 6H are merely examples and are not a definitive list of all possible edge configuration combinations.

It will also be appreciated that the type of configuration of the edges of a GNR depends on the position within the lattice structure of the GNR which is cut to form the edges. For example, within the cut GNRs shown in FIGS. 6A to 6F the type of configuration of the edges of the GNRs vary as a function of the vertical (within the figure) position of a horizontal (within the figure) cut made to create the edges of the GNRs. It will further be appreciated that the type of configuration of the edges of a GNR depends on the relative orientation between the lattice structure of the GNR which is cut to form the edges and the direction of cut. For example, the cuts which are made to create the edges of the GNRs shown in FIGS. 6A to 6F are rotated by 30° relative to the lattice structure of the GNRs compared to the cuts which are made to create the edges of the GNRs shown in FIGS. 6G and 6H.

Each of the FIGS. 7A to 7G is split into three parts. The first part, to the left of each Figure, shows the schematic structure of a bilayer GNR. Within the description of FIGS. 7A to 7G, the terms upper and lower refer to relative positioning on the page. The second part of each Figure, the central part, shows a side view of the schematic structure of the CNT which is formed when the corresponding bilayer GNR is allowed to relax such that the edges of each of the molecular layers of the bilayer multilayer structure covalently bond to one another. Finally, the third part of each Figure, to the right of each Figure, shows the electronic density of states (DOS) of the corresponding formed CNT. The DOS of the formed CNT is a graph of the density of states against the energy of each state. The electronic DOS of the CNTs were obtained using a grid of 1×1×1 100k points.

FIG. 7A shows a bilayer GNR in which the upper layer (shown in black and indicated by 70) of the bilayer GNR has upper and lower edges which have a configuration of the type T₁. Similarly, the lower layer (shown in grey and indicated by 72) of the bilayer GNR also has upper and lower edges which have a configuration of the type T₁. The CNT which is formed when the edges of the bilayer GNR relax so that the edges of the first and second molecular layers covalently bond to one another has a chiral vector of (6,6). FIG. 7A shows that a bilayer GNR having upper and lower layers which both have upper and lower edges which are configured to be of the type T₁ relax to form an armchair CNT with a chiral vector (6,6). Referring to the graph showing the density of states of the formed CNT, it can be seen that the formed CNT has electrical properties which are generally metallic.

The bilayer GNR shown in FIG. 7B has an upper layer 74 (and illustrated in black) and a lower layer 76 (and illustrated in grey) which have the same edge configurations. That is to say, the upper edge of both the upper layer 74 and the lower layer 76 of the GNR are both T₁ type edge configurations. The bottom edge of both the upper layer 74 and lower layer 76 of the GNR has a configuration of the type T₂. FIG. 7B shows that a bilayer GNR in which each of the molecular layers has an upper edge with configuration of type T₁ and a lower edge of configuration type T₂ produces an armchair CNT with a repetitive pentagon-heptagon bond structure. The graph of density of states shows that most of the energy states within the produced CNT may be occupied. Therefore, the CNT is substantially metallic.

FIG. 7C shows a bilayer GNR in which both the upper and lower edges of both the upper layer 78 and lower layer 80 of the GNR have a configuration which is of the type T₂. FIG. 7C shows that a bilayer GNR in which both layers have upper and lower edges having a T₂ type configuration produces an armchair CNT with two repetitive pentagon-heptagon bond-shape pairs. As with the CNT formed from the bilayer GNR shown in FIGS. 7A and 7B, the CNT formed from the bilayer GNR shown in FIG. 7C has a density of states which indicates that the CNT is generally metallic.

FIG. 7D shows a bilayer GNR in which the upper edge of the upper layer 82 of the bilayer GNR is of a configuration of type T₁, and the lower edge of the upper layer 82 of the bilayer GNR has a configuration of the type T₂. Conversely, the upper edge of the lower layer 84 has a configuration of the type T₂, and the lower edge of the lower layer of the bilayer GNR has a configuration of the type T. FIG. 7D shows that a bilayer GNR having an upper layer which has an upper edge of configuration type T₁ and a lower edge of configuration type T₂, and a lower layer having an upper edge configuration type T₂ and a lower edge configuration type T₁ produces an armchair CNT with two lines of non-hexagonal rings which contain octagons, horizontal pentagon pairs and vertical pentagon pairs. Again, as discussed in relation to FIGS. 7A to 7C, the density of states of the CNT which is formed is such that the formed CNT is substantially metallic.

FIG. 7E shows a bilayer GNR in which the upper edge of the upper layer 86 of the bilayer GNR is of a configuration of type T₂, and the lower edge of the upper layer 86 of the bilayer GNR has a configuration of the type T₂. The lower molecular layer 88 has an upper edge of configuration type T₂ and a lower edge of configuration type T. FIG. 7E shows that a bilayer GNR which has an upper layer having an upper edge of configuration type T₂ and a lower edge of configuration type T₂, and a lower molecular layer having an upper edge of configuration type T₂ and a lower edge of configuration type T₁ will relax to a CNT having two lines of non-hexagonal rings. In this case, the top line contains four octagons, one horizontal pentagon pair and three vertical pentagon pairs, and the bottom line contains nine pentagons and heptagons.

The bilayer GNR shown in FIG. 7F has an upper layer 90 having an upper edge with a configuration of the type T₁ and a lower edge having a configuration of the type T₂. The lower layer 92 of the bilayer GNR has upper and lower edges both having a configuration of the type T. FIG. 7F shows that a bilayer GNR having an upper layer with an upper edge of configuration type T₁ and a lower edge of configuration type T₂, and a lower layer having an upper edge of configuration type T₁ and a lower edge of configuration type T₁ will produce an armchair CNT with one line of four octagons, one horizontal pentagon pair and three vertical pentagon pairs. Non-hexagonal rings within CNTs may possess unusual spintronic and electronic properties. As previous discussed in relation to the CNTs shown in FIGS. 7A to 7E, the density of states of the CNT shown in FIG. 7F is such that it may be considered to be generally metallic.

FIG. 7G shows a bilayer GNR in which both of the molecular layers have edges orientated such that the molecular layers are armchair terminated. The upper molecular layer 94 and lower molecular layer 96 both have an upper edge which is configured such that it is of the type T′₁, and a lower edge which is of a configuration of type T′₂. The graph of density of states shows that the occupation of energy states within the CNT is relatively less dense compared to the other CNTs which have been discussed. Consequently, the CNT is generally non-metallic.

The previous examples show that by using the method according to the present invention it is possible to control not only the shape of the produced molecular structure (illustrated by the chiral vector), but also other properties of the produced molecular structure, such as its electrical properties.

In order to produce the desired edge configuration on each of the adjacent molecular layers of the multilayer structure, the structure of the molecular layers must first be measured. The measurement of the structure of the planar molecular layers of the multilayer structure may be carried out using any appropriate measuring device such as, for example, a scanning tunneling microscopy (STM) device. Once the structure of a molecular layer of the multilayer structure has been measured, the molecular layer which has had its structure measured may be arranged in a desired orientation relative to a cutter (such as, for example, an STM lithography device) such that the cutter can be operated so as to break bonds within the molecular layer of the multilayer structure in order to produce an edge of the desired edge configuration which corresponds to the desired shape of molecular structure which will be produced by the multilayer structure.

The cutting process performed by the cutter (i.e., the breaking of bonds in a molecular layer) may occur in an inert atmosphere or in vacuum so that the edge (created by the cutter breaking bonds in the molecular layer) does not bond with an atom with which it is not supposed to bond—i.e., by preventing the edges of two adjacent molecular layers which have been cut using the cutter from bonding with stray atoms, this ensures that the edges of the adjacent molecular layers can relax so that they covalently bond with one another as desired. In other words, by cutting the molecular layers in an inert atmosphere or vacuum, this prevents any cut edges from chemically reacting with the surrounding atmosphere.

In some embodiments of the invention, in order to measure the structure of the first and second adjacent molecular layers, it is not necessary to measure the structure of each of the first and second adjacent molecular layers individually. That is to say, in some embodiments, by measuring the structure of the first generally planar molecular layer, it is possible to infer the structure of the second adjacent generally planar molecular layer. For example, in the case where the multilayer structure is a bilayer graphene structure, the first and second generally planar molecular layers have a known relative orientation in that they may be AB-stacked. Due to the fact that the first and second adjacent generally planar molecular layers in the bilayer graphene structure have a known relative orientation (i.e., are AB-stacked), then by measuring the structure of the first molecular layer it is possible to infer the structure of the second adjacent generally planar molecular layer. Consequently, the multilayer structure (in this case the bilayer graphene structure) can be arranged in a desired orientation relative to the cutter so that the cutter can be used to break bonds within the second generally planar molecular layer so as to produce a second edge which has a desired configuration that corresponds to the shape of the molecular structure to be formed by the method according to the present invention.

Although in the embodiment described above the structure of the first generally planar molecular layer is measured and the structure of the second adjacent generally planar molecular layer is inferred from the measurement of the structure of the first molecular layer, this need not be the case in all embodiments of the present invention. For example, in some embodiments, the structure of the first and second adjacent generally planar molecular layers may be measured separately.

In some embodiments of the invention, once the structure of the first and second adjacent generally planar molecular layers has been determined, the multilayer structure may be arranged in the desired orientation relative to the cutter so that the cutter can break the bonds within the first molecular layer to produce the first edge of a desired configuration and then subsequently the multilayer structure may be arranged in a desired orientation relative to the cutter such that the cutter can be used to break bonds within the second molecular layer so as to produce a second edge of the desired configuration.

In other embodiments, the cutter may comprise two cutting elements such that the multilayer structure can be arranged in a desired orientation relative to the first cutting element such that the first cutting element can break bonds within the first molecular layer to produce the first edge of the desired configuration, and the multilayer structure can simultaneously be arranged in a desired orientation relative to the second cutting element such that the second cutting element can break bonds within the second molecular layer to produce the second edge of the desired configuration. The breaking of bonds in the first molecular layer by the first cutting element and the breaking of bonds within the second molecular layer by the second cutting element may occur simultaneously.

In a further embodiment of the present invention, the multilayer structure may be arranged in a desired orientation relative to the cutter, the cutter having a single cutting element, such that the single cutting element of the cutter can simultaneously break bonds within the first molecular layer to produce the first edge of a first desired configuration and break bonds within the second molecular layer to produce the second edge of a second desired configuration. For example, if it is desired to cut a multilayer structure (in this case bilayer GNR) such that the first edge of the first molecular layer has a T₁ configuration (see FIG. 6A) and it is desired to create a second edge in the second adjacent molecular layer which has a T₂ configuration (see FIG. 6C), then it may be possible to cut both the first and second edges simultaneously using a single cutting element by arranging the multilayer structure such that it is non-perpendicular to a cutting axis of the cutter. This is explained in more detail below.

Arranging the multilayer structure in a desired orientation relative to the cutter and subsequently using the cutter to break bonds may also be referred to as cutting the multilayer structure (or layers of the multilayer structure) along a particular crystallographic direction.

FIG. 8 shows a schematic view of a portion of a multilayer structure 100 being cut by a cutter. In this case the multilayer structure 100 is a bilayer GNR. The multilayer structure 100 has a first generally planar molecular layer 102 and a second generally planar molecular layer 104. The first layer 102 and second layer 104 are adjacent one another. As previously discussed, each of the generally planar molecular layers 102, 104 consists of an array of covalently bonded carbon atoms 106. The first layer 102 and second layer 104 are AB-stacked relative to one another and hence the first and second layers 102, 104 have a known relative orientation.

The multilayer structure 100 has been arranged in a desired orientation relative to a cutter. The cutter acts along a cutting axis 108. When the cutter is operated the cutter breaks bonds between adjacent atoms through which the cutting axis 108 passes. In this case, the multilayer structure 100 is arranged in a desired orientation relative to the cutter such that the cutting axis 108 passes between a first pair of bonded atoms 110 of the first layer 102 and a second pair of bonded atoms 112 of the second layer 104.

The cutter breaks bonds within the first generally planar molecular layer 102 to produce a first edge 114 of a desired configuration (in this case a T₁ configuration) corresponding to a desired shape of molecular structure. The cutter also simultaneously breaks the bond between the atoms 112 within the second generally planar molecular layer 104 to produce a second edge 116 of a desired configuration (in this case a T₂ configuration) corresponding to the desired shape of the molecular structure. In this case the portion of the multilayer structure which will form the desired molecular structure is portion 118 of the first layer 102 and portion 120 of the second layer 104. The first edge 114 of the first generally planar molecular layer 102 and the second edge 116 of the second generally planar molecular layer are allowed to relax so that the first edge 114 of the first generally planar molecular layer 102 and the second edge 116 of the second generally planar molecular layer 104 covalently bond to one another. Consequently, within this embodiment the multilayer structure 100 has been arranged in a desired orientation relative to the cutter such that the first and second edges of desired configuration can be simultaneously cut by the cutter.

FIGS. 9A to 9E show five further CNTs which may be formed from a respective multilayer structure in accordance with the present invention. Each of FIGS. 9A to 9E has three separate parts. The first part on the left of the Figure shows a schematic view of the structure of a multilayer structure. The second, central, part of each Figure shows a schematic cross-section (perpendicular to a longitudinal axis of the CNT) of the structure of the CNT which is produced from the respective multilayer structure shown in the first part of the Figure. The third, right part of each Figure shows a graph of the electronic DOS for each respective formed CNT. The DOS of the formed CNT is a graph of the density of states against the energy of each state. The electronic DOS of the CNTs were obtained using a grid of 1×1×1 100k points.

Referring to the first part of each of FIGS. 9A to 9E, each of the multilayer structures shown in the first part of these Figures shows a portion of an AB-stacked bilayer GNR which as a length L. In this case the length L is equal to 7×≈3/2 a_{c-c} where a_{c-c} is the carbon-to-carbon bond length within a GNR and is approximately equal to 1.44 Å. Although the portion of bilayer GNR which is shown in each of FIGS. 9A to 9E has a length L, it will be appreciated that the bilayer GNR may be considered to be substantially infinitely periodic in the horizontal direction (i.e., parallel to length L).

Each bilayer GNR has an upper monolayer of graphene indicated by UP and a lower monolayer of graphene indicated by LO. As previously discussed, the upper layer UP and lower layer LO are AB-stacked adjacent layers.

In each of the portions of multilayer structure (in this case bilayer GNR) shown in the first part of FIGS. 9A to 9E, the upper and lower edge of each of the upper layer UP and lower layer LO have the same edge configuration which is of type T₁. The edge configurations of each of the layers of the multilayer structures shown in FIGS. 9A to 9E mean that both the upper and lower edges of the upper and lower molecular layers UP, LO are said to be zigzag terminated.

The multilayer structures shown in the first part of each of FIGS. 9A to 9E differ in that they have different widths W.

FIG. 9A shows that an AB-stacked bilayer GNR of width W equal to 3a_{c-c} relaxes to a (2,2) CNT with a 2.95 Å diameter. (2,2) is the chiral vector of the CNT.

FIG. 9B shows that an AB-stacked bilayer GNR of width W equal to 6a_{c-c} relaxes to a (4,4) CNT with a 5.6 Å diameter.

FIG. 9C shows that an AB stacked bilayer GNR of width W equal to 9a_{c-c} relaxes to a (6,6) CNT of 8.29 Å diameter.

FIG. 9D shows that an AB stacked bilayer GNR of width W equal to 12a_{c-c} relaxes to a (8,8) CNT.

Finally, FIG. 9E shows that an AB stacked bilayer GNR of width W equal to 15a_{c-c} relaxes to a (10,10) CNT.

In each of the cases shown in FIGS. 9A to 9E, the bilayer GNR has an upper layer and a lower layer in which both of the upper and lower edges are configured such that they are of the type T₁. The upper and lower edges of both of the upper and lower layers are configured such that both of the upper and lower layers may be said to be zigzag terminated. When the zigzag terminated edges of the layers of the multilayer structure relax so that they covalently bond to one another, armchair type CNTs are produced.

Each of the CNTs shown in FIGS. 9A to 9E have a DOS plot which shows that the electrical configuration of the CNTs may be considered to be metallic.

The spontaneous formation of CNTs from bilayer GNRs is counterintuitive because this is the reverse of a known process in which CNTs can be ‘unzipped’ to form GNRs. However, the experiments demonstrating ‘unzipping’ have only been performed on relatively wide diameter CNTs, whereas, as previously discussed, the formation of CNTs from bilayer GNRs is energetically favored only for small diameter GNRs. This was discussed in relation to FIG. 5 which shows that the energy difference ΔE between CNTs and their corresponding generally bilayer GNRs is a function of the width of the original bilayer GNR. For small values of W this difference is positive, showing that the CNT has the lowest energy and is therefore stable. However, for bilayer GNRs of width greater than approximately 31 Å (3.1 nm) the bilayer GNR is more stable and hence spontaneous formation of CNTs does not occur.

FIG. 10 shows a further molecular structure which can be produced from a multilayer structure in accordance with the present invention. FIG. 10A shows a generally hexagonal annular bilayer GNR which has been cut using a cutter from AB-stacked bilayer graphene. The bilayer GNR 130 is a multilayer structure which has a first generally planar molecular upper layer 132 and a second adjacent generally planar lower molecular layer 134.

As with previous molecular structures that have been produced according to the present invention, once the bilayer GNR has been cut by the cutter to produce a plurality of edges of a desired configuration in the upper layer 132 and a plurality of corresponding edges of a desired configuration in the lower layer 134, the corresponding edges of the upper and lower layers (i.e., first and second layers) are allowed to relax so that the corresponding edges of the first and second layers covalently bond to one another and form bonded pairs of corresponding edges.

FIGS. 10B and 10C show different view of a fullerene torus obtained by allowing the GNR shown in FIG. 10A to relax such that the edges of the adjacent layers covalently bond to one another and the bonded molecular structure subsequently deforms. The molecular structure shown in FIGS. 10B and 10C which is formed according to the present invention is a carbon structure which is completely sp²-bonded.

The structure is topologically distinct from known fullerenes and closed CNTs. Unlike conventional fullerenes, the sp²-bonded torus shown in FIGS. 10B and 10C may exhibit interesting orbital magnetic effects including persistent currents. These features may be a direct consequence of the topology of the torus.

Whereas the CNTs discussed in FIGS. 4B, 7A-G and 9A-E are formed by cutting a bilayer GNR to create parallel bonded pairs of corresponding edges, the fullerene torus of FIG. 10B forms because the bilayer GNR has been cut to create two closed bonded pairs of corresponding edges, with the outer bonded pair of corresponding edges forming a closed loop which encloses the inner bonded pair of corresponding edges. According to the present invention, new molecular structures may be produced by creating different combinations of bonded pairs of corresponding edges and allowing the whole structure to deform.

The fullerene torus has an order of connection k=3. The order of connection k=1+n, where n is the number of closed cuts that can be made on a given surface without breaking it apart into two pieces. Known fullerenes and closed CNTs are topologically equivalent to a sphere and have an order of connection k=1.

The fullerene torus is the simplest example of the hierarchy of sp²-bonded fullerene tori with order of connection k≧3.

FIG. 11 shows a second example of a completely sp²-bonded carbon molecular structure which has been formed from a bilayer GNR in accordance with the present invention. FIG. 11A shows a multilayer structure (in this case a bilayer GNR) which has been cut out using a cutter. It can be seen that the bilayer GNR is generally formed from two hexagons. FIGS. 11B and 11C show the molecular structure which is produced when the edges of the layers of the bilayer GNR are allowed to relax such that the edges of the layers of the bilayer GNR covalently bond to one another and the bonded layers of the bilayer GNR deform. The molecular structure which is formed may be described as a “figure of 8” and has an order of connection k=5.

It will be appreciated by the person skilled in the art that the present invention may be used to produce other multiplely connected topologies with any appropriate order of connection k.

FIGS. 12, 13 and 14 show further examples of molecular structures which can be produced using a method according to the present invention.

FIG. 12 shows an example of a T-branch geometry. FIG. 12A shows an AB-stacked bilayer GNR which has been cut using a cutter. It should be noted that the horizontal portion of the T-branch structure within the Figure may be of any appropriate length. It can be seen in FIG. 12B that when the cut bilayer GNR in FIG. 12A is allowed to relax, the edges of the layers of the bilayer GNR covalently bond to one another to form bonded pairs of corresponding edges. The molecular structure shown in FIG. 12B is a T-branched CNT structure 150. The T-branched CNT structure 150 includes a 10-membered carbon ring 152, two 7-membered carbon rings 154, a 4-membered carbon ring 156, two 3-membered carbon rings 158 and a 9-membered carbon ring 160.

It can be seen that the T-branched molecular structure which may be produced by a method according to the present invention may form part of a T-junction, or in the case of a T-branch CNT structure, may form part of a stub tuner.

FIG. 13A shows a generally cross-shaped bilayer GNR which has been cut using a cutter. FIG. 13B shows a cross-like CNT structure which is produced by allowing the cut bilayer GNR shown in FIG. 13A to relax by allowing the edges of the molecular layers of the bilayer GNR to covalently bond with one another to form bonded pairs of corresponding edges and allowing the bilayer GNR to deform. The cross-like CNT structure 170 includes four 11-membered carbon rings 172.

FIG. 14A shows a further bilayer GNR which has been cut using a cutter. FIGS. 14B to 14E show different views of a nanohorn which has been produced by allowing the cut bilayer GNR to relax so that the edges of the layers of the bilayer GNR covalently bond to one another and such that the bilayer GNR deforms.

All of the previously described molecular structures that have produced according to the present invention have been formed from multilayer structures which are formed from only one type of atom. This need not be the case. For example, layers within the multilayer structure which are cut by the cutter and subsequently allowed to relax so that they covalently bond to one another may have different compositions and/or structures.

FIG. 15A shows a heterobilayer nanoribbon 180 which includes an upper layer 182 of monolayer graphene and a lower monolayer 182 of boron nitride. The boron nitride monolayer 182 is an array of covalently bonded nitrogen and boron atoms. As with graphene, the array of covalently bonded atoms in the boron nitride monolayer is a repeating structure, the repeating structure repeating in two substantially perpendicular directions (e.g., for example, in the directions x and y within the figure). The boron nitride molecular monolayer 184 includes relatively large boron atoms B and relatively small nitrogen atoms N. The graphene monolayer 182 and boron nitride monolayer 184 are AB-stacked.

FIG. 15B shows a side view of a hetero nanotube molecular structure 186 which is formed when the edges of the first generally planar molecular layer (graphene) and the edges of the second generally planar molecular layer (boron nitride) covalently bond to one another to form bonded pairs of corresponding edges.

Consequently, the present invention may be used to produce molecular structures which are formed from a plurality of different types of atom.

Increasing the sp²-bonding of atoms located at the edges of a GNR will increase the chemical and mechanical stability of the edges.

By cutting arrays of holes in multilayer structures (e.g. bilayer GNRs) and allowing the edges of the holes to relax and thereby allowing the edges of adjacent layers to covalently bond to one another to form closed bonded pairs of corresponding edges, the sp²-bonding of atoms located at the interior surfaces of the holes will be increased. An array of reconstructed holes (i.e., with covalent bonding on their internal surfaces) may provide templates for attaching nanoparticles and molecular scale objects to bilayer surfaces.

By cutting arrays of shapes and junctions in a multilayer structure (e.g. a bilayer) and allowing the cut edges of the shapes and junctions to reconstruct, electrical circuits with enhanced electrical, mechanical and chemical properties may be created.

The reconstructed shapes obtained by cutting multilayer structures may be chosen to possess desirable binding energies in relation to biomolecules and cells, thereby allowing the properties of said biomolecules and cells to be altered.

The surfaces and interiors of reconstructed shapes obtained by cutting multilayer structures may be chemically altered to produce new chemical derivatives.

The interiors and exteriors of reconstructed shapes and holes will form hydrophobic or hydrophilic regions, depending on the combination of materials used to form the initial multilayer structure. These regions may be used to bind desirable chemical species.

The size of a molecular structure produced from a multilayer structure according to the present invention is not restricted to the nano-scale and is determined by the size of the initial multilayer structure.

For example, FIGS. 16B and 16C show a further molecular structure which can be produced from a multilayer structure in accordance with the present invention. FIG. 16A shows a generally hexagonal annular bilayer GNR comprising 475 carbon atoms, which has been cut using a cutter from AB-stacked bilayer graphene (which is the multilayer structure in this case). This is a larger version of the bilayer GNR shown in FIG. 10A. When the structure in FIG. 16A relaxes, the torus shown in FIGS. 16B and 16C is obtained. The six corners of this structure are largely spherical molecular structures, whereas the straighter regions connecting the corners are CNTs. Networks of fullerene-like chambers connected by CNTs may form the basis of a nano-fluidic device in which molecules can flow between the chambers via the CNT interconnects.

FIGS. 17B and 17C show schematic views of an example of a molecular structure in the form of a fullerene-like chamber which may be produced in accordance with a further embodiment of the present invention. The molecular structure shown in FIGS. 17B and 17C are produced from the cut multilayer structure shown schematically in FIG. 17A. The cut multilayer structure shown in FIG. 17A is a generally disc-shaped bilayer GNR, which has been cut using a cutter from AB-stacked bilayer graphene. After relaxation, this forms the fullerene-like chamber shown in FIGS. 17B and 17C.

Although in the previously described embodiments the multilayer structure used to produce a molecular structure according to the present invention is a bilayer structure, any appropriate multilayer structure may be used. For example, the multilayer structure may have any appropriate number of adjacent generally planar molecular layers provided that this number is at least two. In some embodiments, it may be advantageous for the multilayer structure to have a number of adjacent generally planar molecular layers which is a multiple of two. In this way the multilayer structure may consist of pairs of adjacent generally planar molecular layers, each pair of molecular layers covalently bonding when cut by a cutter and allowed to relax. Adjacent pairs of molecular layers which covalently bond to one another in this manner may bond to an adjacent covalently bonded pair of molecular layers by relatively weak bonding, such as van der Waals forces.

Multilayer structures with more than two layers (and hence more than one pair of adjacent generally planar molecular layers) may be used to produce connected CNTs and other connected shapes of molecular structure. This allows molecular structures which comprise stacks of connected planes of nanotubes or other molecules to be created. Examples of this are shown in FIGS. 18A and 18B.

The left portion of FIG. 18A shows a schematic perspective view of a portion of a multilayer structure which has been cut from a 4-layer AB-stacked GNR. The right portion of FIG. 18A shows a schematic view of the molecular structure which is formed when the cut multilayer structure shown in the left portion of FIG. 18A is allowed to relax so that covalent bonds form between adjacent layers and so that the adjacent layers deform.

The left portion of FIG. 18B shows a schematic perspective view of a multilayer a portion of a structure which has been cut from a 6-layer AB-stacked GNR. The right portion of FIG. 18B shows a schematic view of the molecular structure which is formed when the cut multilayer structure shown in the left portion of FIG. 18B is allowed to relax so that covalent bonds form between adjacent layers and so that the adjacent layers deform.

The resulting relaxed structures shown in the right portions of FIGS. 18A and 18B are substantially parallel CNTs connected along their lengths.

In some embodiments, such as those shown in FIGS. 10B, 10C, 11B, 11C, 16B and 16C, the molecular structure produced by the present invention may comprise at least one hole (or aperture). In this case, a hole (or aperture) is cut by the cutter in first and second adjacent generally planar molecular layers. The hole is defined by corresponding closed bonded edges in each of the first and second layers. The edge of the first cut hole in the first layer and the edge of the second cut hole in the second layer then relax so that the edge of the first hole in the first layer and the edge of the second hole in the second layer covalently bond to one another. Consequently, the molecular structure which is produced has a hole (or aperture) which passes through the molecular structure and which is defined by an internal surface of the molecular structure which is produced by the covalent bonding between the first and second molecular layers (when relaxation of the edges of holes in the first and second molecular layers which are cut by the cutter occurs).

Further examples of embodiments in which the molecular structure produced by the present invention includes at least one hole (or aperture) are discussed below.

FIG. 19B shows a molecular structure which can be produced from a multilayer structure in accordance with the present invention. FIG. 19A shows two bilayer GNRs on either side of a generally hexagonal annular bilayer GNR which has been cut using a cutter from AB-stacked bilayer graphene (which is the multilayer structure in this case). The edges of the cut molecular layers shown in FIG. 19A relax and covalently bond to one another to form a torus connected between two CNTs. The torus has a hole (or aperture) generally at its centre.

FIG. 20B shows another molecular structure which can be produced from a multilayer structure in accordance with the present invention. FIG. 20A shows a hole which has been cut using a cutter in each of the layers in AB-stacked bilayer graphene (which is the multilayer structure in this case). The edges of the hole cut in each of the molecular layers shown in FIG. 20A relax and covalently bond to one another to form a hole (or aperture) which passes through the two layers of the molecular structure. The hole (or aperture) of the molecular structure shown in FIG. 20B which results from the relaxation and covalent bonding of the edges of the hole cut in each of the molecular layers shown in FIG. 20A has maximised sp² bonding within the internal surface of the hole.

FIGS. 4B and 4C show a molecular structure 64 produced in accordance with the present invention from a multilayer structure cut as shown in FIG. 4A. The central portion of the molecular structure 64 forms a CNT 66; whereas the end portions 50a, 52a of the molecular structure 64 are generally planar molecular layers at either end of the CNT 66. The reasoning behind why a portion of the cut multilayer structure forms a CNT and another portion of the cut multilayer structure remains as generally planar molecular layers has already been discussed and will not be repeated here.

FIGS. 21B and 21C show plan and side views of an alternative molecular structure produced in accordance with the present invention. The molecular structure shown in FIGS. 21B and 21C is produced by allowing the multilayer structure cut as shown in FIG. 21A to relax and the edges of the cut multilayer structure to covalently bond. In contrast to the molecular structure shown in FIGS. 4B and 4C which includes a CNT with generally planar molecular layers at each end of the CNT, the molecular structure shown in FIGS. 21B and 21C includes a central CNT of relatively small diameter with CNTs of relatively large diameter connected to either end of the central CNT. In this embodiment the central CNT and CNTs at either end of the central CNT are co-axial. In other embodiments, this need not be the case.

The reason that the end portions (i.e. those portions at either end of the central CNT) of the molecular structure shown in FIGS. 21B and 21C are CNTs, whereas the end portions of the molecular structure shown in FIGS. 4B and 4C are generally planar, is because the widths of the end portions of the cut multilayer structure shown in FIG. 21A which forms the molecular structure shown in FIGS. 21B and 21C are sufficiently small to make it energetically more favourable for the end portions of the cut multilayer structure shown in FIG. 21A to form CNTs, whereas the widths of the end portions of the cut multilayer structure shown in FIG. 4A which forms the molecular structure shown in FIGS. 4B and 4C are sufficiently large to make it energetically more favourable for the end portions of the cut multilayer structure shown in FIG. 4A to remain as generally planar molecular layers. Again, the reasoning behind why a portion of a cut multilayer structure forms a CNT or remains as generally planar molecular layers has already been discussed and will not be repeated here.

Within the embodiment shown in FIGS. 21B and 21C the central CNT has a diameter which is less than the diameter of the CNTs at either end of the central CNT. In other embodiments this need not be the case. In such other embodiments one of (or both) of the CNTs at either end of the central CNT may have a diameter which is less than the diameter of the central CNT.

Within the embodiment shown in FIGS. 21B and 21C the CNTs at either end of the central CNT each have substantially the same diameter. In other embodiments this need not be the case. That is to say, in such embodiments, the diameters of the three CNTs may be different. In such other embodiments the CNTs at either end of the central CNT each have different diameters. For example, in some embodiments, the CNTs at either end of the central CNT may each have different diameters and may each have a diameter which is greater than that of the central CNT. In other embodiments the CNTs at either end of the central CNT may each have different diameters and may each have a diameter which is less than that of the central CNT. In still further embodiments the CNTs at either end of the central CNT may each have different diameters, one of the CNTs at an end of the central CNT having a diameter which is greater than that of the central CNT and the other of the CNTs at an end of the central CNT having a diameter which is less than that of the central CNT.

Molecular structures in the form of connected stacks of nanotubes and molecular structures produced in accordance with the present invention have potential applications to nanoelectronics and nano-fluidics.

Potential applications for the covalently bonded molecular structures produced in accordance with the present invention include superconductors, lubricants, catalysts, drug delivery systems, pharmaceuticals, hydrogen storage, optical devices, chemical sensors, photovoltaics, polymer electronics (e.g., organic field-effect transistors (OFETS)), antioxidants, polymer additives, cosmetics (i.e., to mop-up free radicals) and precursors to produce diamond films.

Like C₆₀ (buckminsterfullerene) and CNTs, the covalently bonded molecular structures produced by the method according to the present invention may be modified by encapsulation with biopolymers or by covalent linking of solubilising groups to the external walls and tips. Like CNTs, the molecular structures produced by the method according to the present invention may be capable of entering biological cells and may therefore serve as a drug delivery vehicle. This is because drugs may be stored in the hollow interior of a molecular structure created by the method according to the present invention, or may be attached to the surface of such a molecular structure and subsequently transported into biological cells.

To facilitate the incorporation of drugs or other molecules into molecular structures produced according to the present invention, it may be desirable to cut a multilayer structure using a cutter in the presence of an atmosphere or fluid containing the drugs or other molecules.

The covalently bonded molecular structures produced by the method according to the present invention may be used for hydrogen storage.

Although the cutter described in the previous embodiments is an STM lithography device, it will be appreciated that any other appropriate cutter may be used. For example, a focused ion beam device, a focused helium beam lithography device, chemical treatment or catalytic hydrogenation may be used.

It will be appreciated that, although the previously described embodiments all involve multilayer structures in which the adjacent layers of the multilayer structure are AB-stacked, in other embodiments the adjacent layers of the multilayer structure may have any appropriate stacking. For example, the adjacent molecular layers may adopt AA-stacking, in which atoms in one layer lay directly above atoms in an adjacent layer. It will also be appreciated that in embodiments of the invention in which the adjacent molecular layers of the multilayer structure have a known stacking, the molecular layers will have a known relative orientation.

It has previously been discussed that, in relation to bilayer graphene, it is energetically favourable for bilayer GNRs which are cut having a width of less than about 31 Å to form nanotubes (in this case CNTs). Conversely, for bilayer GNRs it is energetically favourable for bilayer GNRs having a width which is greater than about 31 Å to maintain a generally bilayer structure. About 31 Å may therefore be said to be a critical width. It will be appreciated that in the case of heterobilayers, the same principle will apply (i.e., above a certain width of bilayer nanoribbon the heterobilayer will form a nanotube, and above a certain width of bilayer nanoribbon the bilayer nanoribbon will remain as a generally bilayer structure). However, the critical width will be different depending on the composition of the hetero-bilayer.

In some embodiments of the invention, before the cutter is used to break bonds within the first and/or second molecular layer of the multilayer structure, the multilayer structure may be cooled to a temperature at which the relaxation of the first edge of the first molecular layer and the second edge of the second molecular layer (i.e., so that the first edge and second edge covalently bond to one another) may be substantially prevented. Once the cutter has broken a desired number of bonds within the first and/or second molecular layer of the multilayer structure, the multilayer structure may be subsequently heated to a temperature at which the first edge of the first molecular layer and the second edge of the second molecular layer are permitted to relax so that the first edge and second edge can covalently bond to one another.

It will be appreciated that numerous modifications to the above described designs may be made without departing from the scope of the invention as defined in the appended claims.

What is claimed is:

1. A method of producing a molecular structure, the method comprising:
determining a desired shape of the molecular structure;
providing a multi-layer structure, the multilayer structure having at least first and second adjacent generally planar molecular layers, the first and second generally planar molecular layers each consisting of an array of covalently bonded atoms;
arranging the multi-layer structure in a desired orientation relative to a cutter;
using the cutter to break bonds within the first generally planar molecular layer to produce a first edge of a desired configuration corresponding to the desired shape of the molecular structure;
using the cutter to break bonds within the second generally planar molecular layer to produce a second edge of a desired configuration corresponding to the desired shape of the molecular structure; and
allowing the first edge of the first generally planar molecular layer and the second edge of the second generally planar molecular layer to relax so that the first edge of the first generally planar molecular layer and the second edge of the second generally planar molecular layer covalently bond to one another.

2. A method according to claim 1, wherein the multi-layer structure is a bi-layer structure.

3. A method according to claim 1, wherein the first and second generally planar molecular layers have a known relative orientation.

4. A method according to claim 1, wherein the array of covalently bonded atoms of one or both of the first and second adjacent generally planar molecular layers is a repeating structure, the repeating structure repeating in two substantially perpendicular directions.

5. A method according to claim 1, wherein the first and/or second generally planar molecular layers are one atom thick.

6. A method according to claim 1, wherein at least one of the first and second generally planar molecular layers is a graphene layer.

7. A method according to claim 1, wherein the first and second generally planar molecular layers have substantially the same composition and/or structure.

8. A method according to claim 7, wherein the first and second generally planar molecular layers are graphene layers.

9. A method according to claim 1, wherein the first and second generally planar molecular layers have different compositions and/or structures.

10. A method according to claim 1, wherein the first and second adjacent generally planar molecular layers are AB-stacked.

11. A method according to claim 1, wherein a scanning tunnelling microscope is used to arrange the multi-layer structure in a desired orientation relative to the cutter, and wherein the cutter is a scanning tunnelling microscope lithography device.

12. A method according to claim 1, wherein the method further includes cooling the multilayer structure to a temperature at which the relaxation of the first edge of the first generally planar molecular layer and the second edge of the second generally planar molecular layer is relatively inhibited; and subsequently heating the multilayer structure to a temperature at which the relaxation of the first edge of the first generally planar molecular layer and the second edge of the second generally planar molecular layer is relatively permitted.

13. A method according to claim 1, wherein the cutter simultaneously breaks bonds within the first and second generally planar molecular layers to produce the first edge and the second edge respectively.

14. A method according to claim 1, wherein the first edge of the first generally planar molecular layer and the second edge of the second generally planar molecular layer covalently bond to one another via sp² covalent bonding.

15. A method according to claim 1, wherein the first edge of the first generally planar molecular layer and the second edge of the second generally planar molecular layer covalently bond to form a first bonded pair of corresponding edges, and wherein the first bonded pair of corresponding edges forms a closed loop.

16. A method according to claim 1, wherein the first edge of the first generally planar molecular layer and the second edge of the second generally planar molecular layer covalently bond to form a first bonded pair of corresponding edges, and wherein the molecular structure comprises at least one further bonded pair of corresponding edges, the or each of the at least one further bonded pair of edges being formed by:
allowing first and second edges of a pair of corresponding edges to relax so that the first and second edges of the pair of corresponding edges covalently bond to one another, wherein to produce each pair of corresponding edges:
the cutter break bonds within the first generally planar molecular layer to produce a first edge of the pair of corresponding edges of a desired configuration corresponding to the desired shape of the molecular structure; and
the cutter breaks bonds within the second generally planar molecular layer to produce a second edge of the pair of corresponding edges of a desired configuration corresponding to the desired shape of the molecular structure; and
wherein first bonded pair of corresponding edges interacts with the at least one further bonded pair of corresponding edges to form the desired molecular structure.

17. A method according to claim 1, wherein the desired shape of the molecular structure includes a hole through a portion of the molecular structure; and
wherein the first edge of the first generally planar molecular layer and the second edge of the second generally planar molecular layer relax so that the first edge of the first generally planar molecular layer and the second edge of the second generally planar molecular layer covalently bond to one another to form an internal surface of the molecular structure which defines the hole through the portion of the molecular structure.

18. A method according to claim 17, wherein the first edge is a closed bonded edge which defines a hole through the first generally planar molecular layer; and the second edge is a closed bonded edge which defines a hole through the second generally planar molecular layer.

19. A molecular structure produced using the method of claim 1.
